(19) United States
(12) Patent Application Publication
(10) Pub. No.: US 2026/0029085 A1
(43) Pub. Date: Jan. 29, 2026

(54) Apparatus for Multi-Dimensional Positioning of an Object From Planar Circumferential Movement

(71) Applicants: Matthew Neber, Miami, FL (US); Hohyun Lee, Santa Clara, CA (US)

(72) Inventors: Matthew Neber, Miami, FL (US); Hohyun Lee, Santa Clara, CA (US)

(21) Appl. No.: 18/786,345

(22) Filed: Jul. 26, 2024

(51) Int. Cl. F16M 11/20; H02S 20/30

(52) U.S. Cl. CPC F16M 11/2064; H02S 20/30

(57) ABSTRACT

An apparatus for positioning an object includes a nonlinear rail; a first carriage translationally and a second carriage slidably coupled to the nonlinear rail for nonlinear movements along the nonlinear rail; a mount for supporting the object; and a frame coupled to the mount and including: (i) a first support member rotatably coupled to the first carriage; (ii) a second support member distinct and separate from the first support member and rotatably coupled to the second carriage; and (iii) a third support member distinct and separate from the first support member and the second support member for converting movements of the first support member, the second support member, and the third support member caused by the nonlinear movements of the first carriage or the second carriage to at least one of translation or rotation of the mount. Methods for operating the apparatus are also described.

### TECHNICAL FIELD

This application relates generally to methods and apparatus for positioning an object, and more particularly to methods and apparatus for positioning an object based on planar circumferential movements.

### BACKGROUND

Mechanical positioning of an object in a three-dimensional space is needed for a large number of applications. For example, a plurality of heliostats (devices with reflectors on turning mounts) in a heliostat field is used to concentrate the Sun's energy onto a single point for harvesting solar energy. Tens of thousands of heliostats reflect the Sun onto a target called a receiver whereby a multitude of different methods can be employed to harvest the immense amount of energy. Heliostat fields provides solar concentration. However, several limitations exist for heliostat fields.

Heliostats are required to track the Sun throughout the day and reflect its radiance onto the receiver. Since the distance between a heliostat and a receiver can often be over one kilometer, the precision and accuracy required of each heliostat to perform its function is one of the main drivers for cost. The cost of the heliostat field in relation to the entire energy harvesting system is significant, and historically, this has been prohibitive to the mass adoption of this technology to the utility power supply sector.

In addition, conventional methods of installing a heliostat are labor intensive. Traditional heliostat designs anchor into the ground with a single large pylon. The pylon installation requires a large diameter hole to be drilled first, followed by vibro-hammer or impact pile drivers for insertion. Due to the nature of pile insertion, it cannot be performed with the heliostat installed on the pylon. As a result, the pylon needs to be installed without a heliostat pre-mounted on the pylon, and installation of the heliostat onto the pylon needs to be performed as a separate, third step in the process. This three-step process is achieved with a considerable amount of labor, which adds to the cost of field installation.

### SUMMARY

Accordingly, there is need for cost-effective, methods and apparatus that allow precise positioning of an object (e.g., a solar reflector) in a three-dimensional space. Such methods and apparatus may be implemented for a large number of positioning devices (e.g., apparatus that follow a celestial object, such as photovoltaic tracker, telescopes, etc. and a robotic system that needs precise surface normal control with multiple degrees of motion from a single central location, such as an end effector in a manufacturing equipment).

Described herein are apparatus and methods that allow positioning of an object based on planar circumferential movements of carriages along a nonlinear rail (e.g., a circular track). Such apparatus and methods allow both translational and rotational movements of the object by converting the planar circumferential movements of carriages into translational and rotational movements of the object, including translational and rotational movements off the plain of the planar circumferential movements, using a linkage.

A number of embodiments that overcome the limitations and disadvantages of existing methods and apparatus are presented in more detail below. These embodiments provide methods and apparatus for positioning an object.

As described in more detail below, in accordance with some embodiments, an apparatus for positioning an object includes a nonlinear rail; a first carriage slidably coupled to the nonlinear rail for nonlinear movements along the nonlinear rail; a second carriage distinct and separate from the first carriage and slidably coupled to the nonlinear rail for nonlinear movements along the nonlinear rail; a mount for supporting the object; and a frame coupled to the mount and including: (i) a first support member rotatably coupled to the first carriage; (ii) a second support member distinct and separate from the first support member and rotatably coupled to the second carriage; and (iii) a third support member distinct and separate from the first support member and the second support member for converting movements of the first support member, the second support member, and the third support member caused by the nonlinear movements of the first carriage or the second carriage to at least one of translation or rotation of the mount.

In some embodiments, the nonlinear rail defines a closed path for the first carriage and the second carriage.

In some embodiments, the nonlinear rail comprises: a first end of the nonlinear rail; and a second end of the nonlinear rail, opposite to the first end of the nonlinear rail. The first end and the second end of the nonlinear rail are not in contact with each other and the nonlinear rail extends nonlinearly from the first end to the second end.

In some embodiments, the frame includes a first block rotatably coupled to the first support member and the second support member for rotation about respective rotational axes parallel to each other. The first block is pivotally coupled to the third support member for rotation about a first pivotal axis perpendicular to the respective rotational axes.

In some embodiments, the first block includes a first plate that defines a first slot, a second slot in line with the first slot, and a third slot perpendicular to the first slot and the second slot and positioned at an equal distance to the first slot and the second slot. The first support member includes a first pin slidably coupled to the first slot. The second support member includes a second pin slidably coupled to the second slot. The first support member and the second support member are rotatably coupled to a common pin that is slidably coupled to the third slot.

In some embodiments, the first block includes a second plate distinct and separate from the first plate, the second plate defining a fourth slot parallel to the third slot; at least a portion of the first support member and the second support member is located between the first plate and the second plate; and the common pin is slidably coupled to the fourth slot.

In some embodiments, the second plate defines a fifth slot parallel to the first slot and a sixth slot in line with the fourth slot; the first support member includes a third pin slidably coupled to the fifth slot; and the second support member includes a fourth pin slidably coupled to the sixth slot.

In some embodiments, the frame includes one or more linkages, a respective linkage of the one or more linkages being pivotably coupled to the first block so that the respective linkage is pivotable about a second pivotal axis parallel to the first pivotal axis.

In some embodiments, the respective linkage includes the respective linkage includes (a) a first link pivotably coupled to the first block about the second pivotal axis and (b) a second link pivotably coupled to the first link about a third pivotal axis parallel to the first pivotal axis, pivotably coupled to the third support member about a fourth pivotal axis parallel to the first pivotal axis, and pivotably coupled to the mount about a fifth pivotal axis parallel to the first pivotal axis.

In some embodiments, the third support member is pivotably coupled to the mount about a sixth pivotal axis parallel to the first pivotal axis.

In some embodiments, the frame includes a first block, a second block rotatably coupled to a first end of the first block, and a third block rotatably coupled to a second end, opposite to the first end, of the first block. The first support member includes a first arm and a second arm distinct from the first arm. The second support member includes a third arm and a fourth arm distinct from the third arm. The first arm and the third arm are rotatably coupled to the first block. The second arm is rotatably coupled to the second block. The fourth arm is rotatably coupled to the third block.

In some embodiments, the frame includes a first block (i) rotatably coupled to the first support member for rotation about a first rotational axis, (ii) rotatably coupled to the second support member for rotation about a second rotational axis that is non-parallel to the first rotational axis, and (iii) pivotally coupled to the third support member for rotation about a first pivotal axis that is non-parallel to the first rotational axis and the second rotational axis.

In some embodiments, the frame includes one or more linkages, a respective linkage of the one or more linkages being pivotably coupled to the first block so that the respective linkage is pivotable about a second pivotal axis parallel to the first pivotal axis.

In some embodiments, the apparatus further includes a third carriage that is (1) distinct and separate from the first carriage and the second carriage, (2) slidably coupled to the nonlinear rail for nonlinear movements along the nonlinear rail, and (3) rotationally coupled to the third support member; a fourth carriage that is (1) distinct and separate from the first carriage, the second carriage, and the third carriage and (2) slidably coupled to the nonlinear rail for nonlinear movements along the nonlinear rail; and a fifth carriage that is (1) distinct and separate from the first carriage, the second carriage, the third carriage, and the fourth carriage and (2) slidably coupled to the nonlinear rail for nonlinear movements along the nonlinear rail. The frame also includes (iv) a fourth support member that is (1) distinct and separate from the first support member, the second support member, and the third support member, (2) rotatably coupled to the fourth carriage, and (3) rotatably coupled to the mount; and (v) a fifth support member that is (1) distinct and separate from the first support member, the second support member, the third support member, and the fourth support member, (2) rotatably coupled to the fifth carriage, and (3) rotatably coupled to the mount.

In some embodiments, the apparatus further includes (vi) a sixth support member (1) distinct and separate from the first support member, the second support member, the third support member, the fourth support member, and the fifth support member, and (2) rotatably coupled to the mount.

In some embodiments, the first support member is rotatably coupled to the mount at a first location of the mount. The second support member is rotatably coupled to the mount at a second location of the mount adjacent to the first location of the mount. The third support member is rotatably coupled to the mount at a third location of the mount adjacent to the second location of the mount. The fourth support member is rotatably coupled to the mount at a fourth location of the mount. The fifth support member is rotatably coupled to the mount at a fifth location of the mount. The sixth support member is rotatably coupled to the mount at a sixth location of the mount. The first location is separated from the second location by a first distance and the third location is separated from the second location by a second distance distinct from the first distance.

In some embodiments, a respective support member of the first support member and the second support member is rotatably coupled to a caster with a caster body and one or more wheels rotatable about a wheel axis relative to the caster body. The caster body is rotatable with the respective support member about a caster body axis perpendicular to the wheel axis. The one or more wheels of the respective support member are in contact with the nonlinear rail.

In some embodiments, the one or more wheels of the respective support member have a substantially spherical shape.

In some embodiments, the nonlinear rail includes a first portion with a rail track and a second portion with a plurality of gear teeth.

In some embodiments, a respective carriage of the first carriage and the second carriage includes one or more drive actuators mated to the plurality of gear teeth such that activation of the one or more drive actuators causes a nonlinear movement of the respective carriage along the nonlinear rail.

In some embodiments, the apparatus further includes a controller electrically coupled to the first carriage and the second carriage for causing the nonlinear movements of the first carriage and the second carriage along the nonlinear rail.

In accordance with some embodiments, a method of adjusting a position of an object mounted on any apparatus described herein includes moving the first carriage and the second carriage symmetrically to each other to concurrently adjust a height and a pitch of the object without adjusting a lateral position or a yaw of the object; and moving at least one of the first carriage or the second carriage non-symmetrically to each other to concurrently adjust at least a lateral position and a yaw of the object.

In some embodiments, moving at least one of the first carriage or the second carriage non-symmetrically to each other concurrently adjusts the height, the pitch, the lateral position, and the yaw of the object.

In accordance with some embodiments, an apparatus for positioning an object includes a first nonlinear rail; a second nonlinear rail; a first carriage slidably coupled to the first nonlinear rail for nonlinear movements along the first nonlinear rail; a second carriage distinct and separate from the first carriage and slidably coupled to the second nonlinear rail for nonlinear movements along the second nonlinear rail; a mount for supporting the object; a first support member rotatably coupled to the first carriage; a second support member distinct and separate from the first support member and rotatably coupled to the second carriage; a third support member distinct and separate from the first support member and the second support member; and a frame coupled to the mount and rotatably coupled to the first support member, the second support member, and the third support member for converting movements of the first support member, the second support member, and the third support member caused by the nonlinear movements of the first carriage or the second carriage to at least one of translation or rotation of the mount.

The apparatus and methods described herein address may replace conventional apparatus and methods. Alternatively, the apparatus and methods described herein address may complement conventional apparatus and methods.

### BRIEF DESCRIPTION OF THE DRAWINGS

For a better understanding of the aforementioned embodiments as well as additional embodiments, reference should be made to the Description of Embodiments below, in conjunction with the following drawings in which like reference numerals refer to corresponding parts throughout the figures.

FIGS. 1A-1D illustrate an apparatus for positioning an object in accordance with some embodiments.

FIGS. 1E-1H illustrate a portion of the apparatus shown in FIGS. 1A-1D in accordance with some embodiments.

FIG. 1I is an exploded view of a center block of the apparatus shown in FIGS. 1A-1H in accordance with some embodiments.

FIGS. 2A-2D illustrate an apparatus for positioning an object in accordance with some embodiments.

FIG. 2E is an exploded view of a center block of the apparatus shown in FIGS. 2A-2D in accordance with some embodiments.

FIGS. 2F-2K illustrate an apparatus for positioning an object in accordance with some embodiments.

FIG. 2L is an exploded view of a center block of the apparatus shown in FIGS. 2F-2K in accordance with some embodiments.

FIG. 3 illustrates an apparatus for positioning an object in accordance with some embodiments.

FIG. 4A illustrates a base 400 in accordance with some embodiments.

FIGS. 4B-4E are schematic diagrams illustrating plan views of the base 400 in accordance with some embodiments.

FIGS. 5A-5C illustrate parts of a carriage in accordance with some embodiments.

FIG. 6 is an exploded view of a caster in accordance with some embodiments.

FIGS. 7A-7C illustrate operations of the caster on a nonlinear rail in accordance with some embodiments.

FIG. 7D illustrates circumferential movement of a carriage in accordance with some embodiments.

FIGS. 8A-8C illustrate a payload mounted on a positioning apparatus in accordance with some embodiments.

FIG. 9 is a flow diagram illustrating a method of operating a positioning apparatus in accordance with some embodiments.

FIG. 10 is a block diagram illustrating electronic components of a positioning apparatus in accordance with some embodiments.

Like reference numerals refer to corresponding parts throughout the drawings.

Drawings are not necessarily drawn to scale unless indicated otherwise.

### DESCRIPTION OF EMBODIMENTS

In systems that require precise positioning and long life, precision components with large load profiles are employed, which are typically expensive. Anti-backlash components usually require precision machining, which is costly and time consuming. For precise positioning of large loads, high mechanical advantage (e.g., force amplification) is generally necessary. A common tactic uses geared reduction in which the force must be transmitted through a sequence of precision components without loss of precision. There is a risk and high cost associated with systems that use this method. Alternate designs employ methods to achieve high reduction with fewer gears, such as harmonic and planocentric drives. However, these systems suffer from wear since their working basis uses gears in an unconventional mesh and/or part deformation. Power transmission through high reduction ratios with great precision and without backlash over a long lifespan is a well-known design challenge.

A platform based on two orthogonal linear actuators can provide accurate positioning of an object. However, a platform with orthogonal linear actuators has a limited range of trackability, due to a finite length of travel for linear actuators.

As described herein, apparatus and methods that utilize two or more actuators on one or more nonlinear guide rails provide an increased range of motion for positioning an object. The one or more nonlinear guide rails may serve as a base for the entire system. The payload (e.g., a photovoltaic panel, a reflector, etc.) is supported by a frame, which is linked to the two actuators on the base via a linkage frame. As the actuators move around the base, their relative motion articulates the frame so that the payload can move around, including, in some configuration, throughout a full hemispherical range.

Throughout this application, reference will be made to certain embodiments, examples of which are illustrated in the accompanying drawings. While the claims will be described in conjunction with the embodiments, it will be understood that it is not intended to limit the claims to these particular embodiments alone. On the contrary, the embodiments are intended to cover alternatives, modifications and equivalents that are within the spirit and scope of the appended claims.

Moreover, in the following description, numerous specific details are set forth to provide a thorough understanding of the embodiments. However, it will be apparent to one of ordinary skill in the art that the embodiments may be practiced without these particular details. In other instances, methods, procedures, and components that are well-known to those of ordinary skill in the art are not described in detail to avoid obscuring aspects of the embodiments.

It will also be understood that, although the terms first, second, etc. may be used herein to describe various elements, these elements should not be limited by these terms. These terms are only used to distinguish one element from another. For example, a first carriage could be termed a second carriage, and, similarly, a second carriage could be termed a first carriage, without departing from the scope of the embodiments. The first carriage and the second carriage are both carriages, but they are not the same carriage.

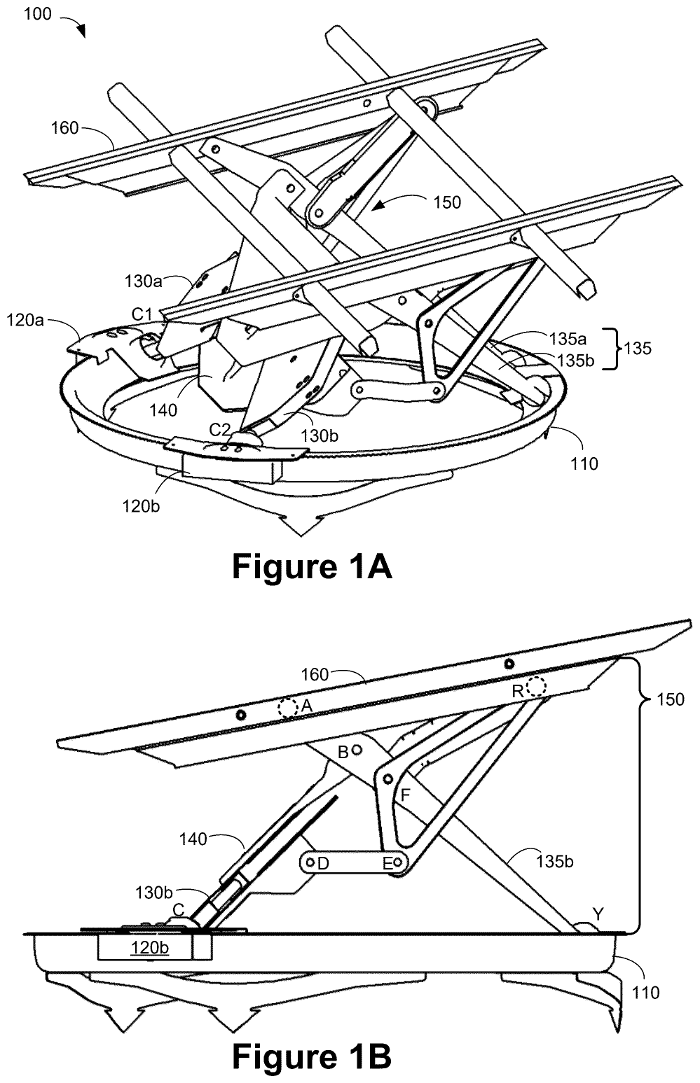

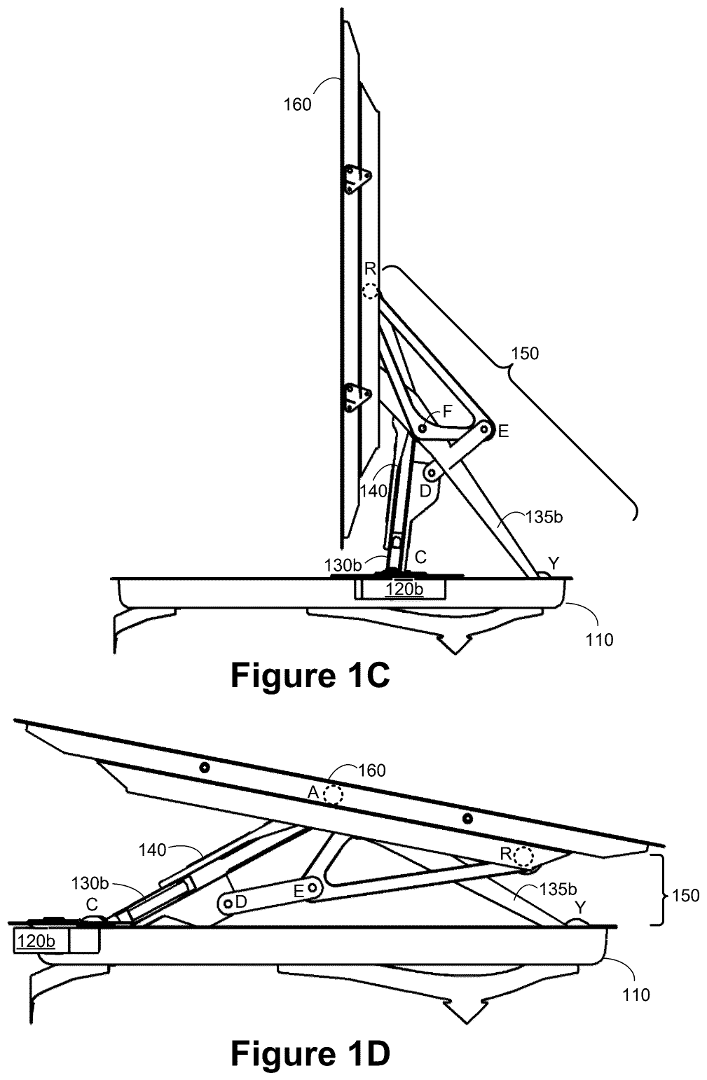

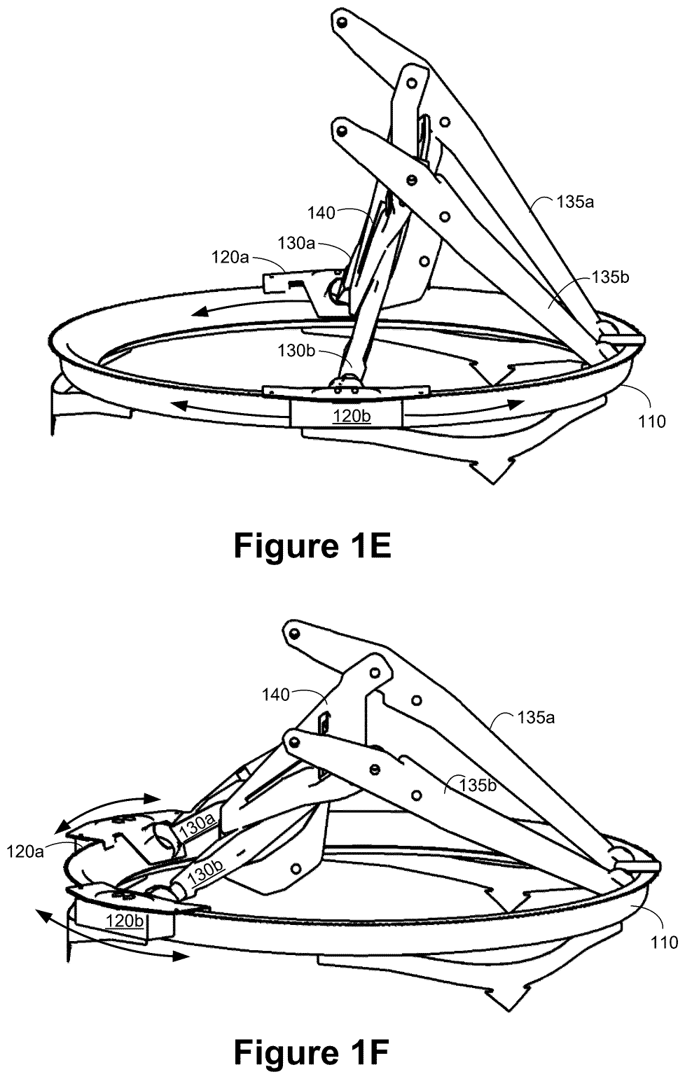

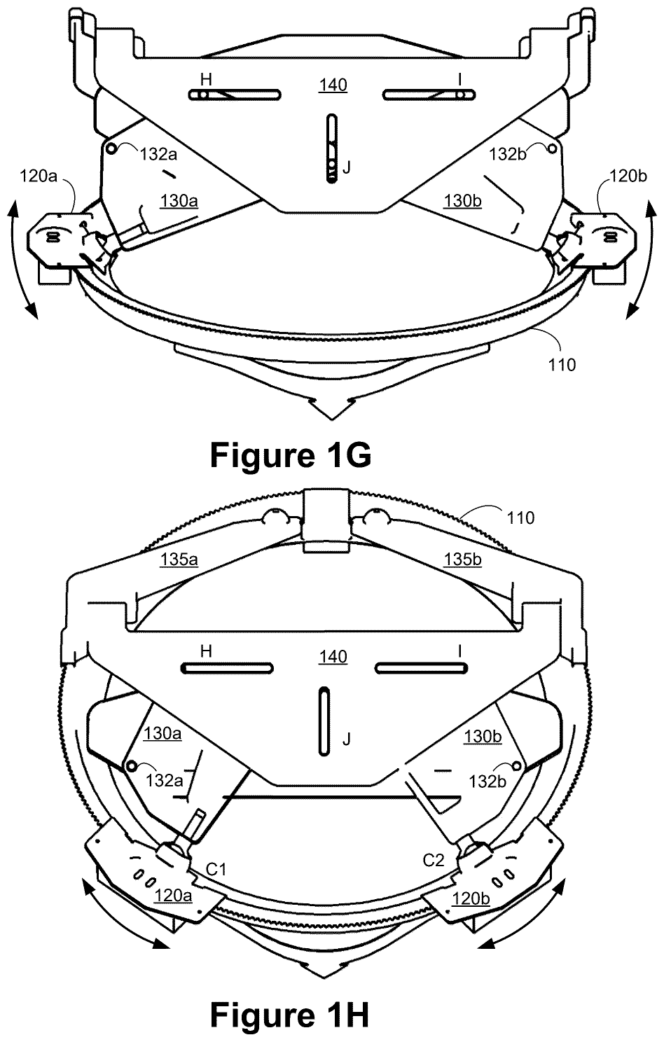

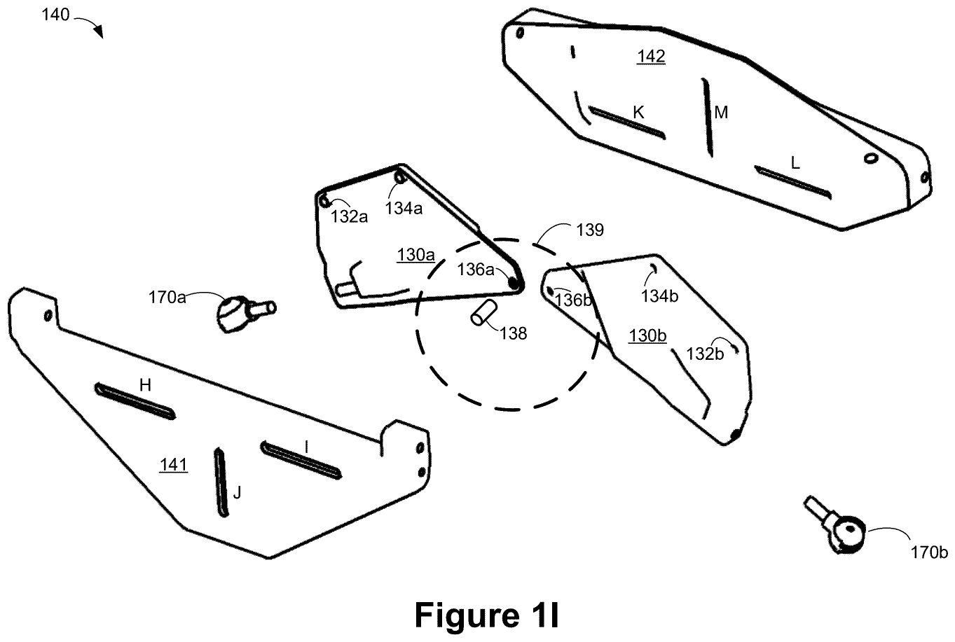

FIGS. 1A-1D illustrate an apparatus 100 for positioning an object (e.g., a payload, such as a solar panel, a solar reflector, an antenna, or a satellite dish) in accordance with some embodiments, where FIG. 1A is a perspective view of the apparatus 100.

The apparatus 100 includes a nonlinear rail 110 (e.g., a circular guide rail), a first carriage 120a (also labeled C1), and a second carriage 120b (also labeled C2) that is distinct and separate from the first carriage 120a. The first carriage 120a and the second carriage 120b are slidably coupled to the nonlinear rail 110 for nonlinear movements (e.g., circumferential movements) along the nonlinear rail 110.

The apparatus 100 also includes a frame 150 that provides a scissor motion. The apparatus 100 utilizes the scissor motion of the frame 150 to provide simultaneous control of both the height and zenith angle (or pitch angle) of an object (not shown in FIG. 1A so as not to obscure other parts of the apparatus 100).

The apparatus 100 further includes a mount 160 for supporting the object. In some embodiments, the mount 160 is rotationally coupled to elements of the frame 150 at rotational joints A and R (e.g., each rotational joint may include a pin or a roller).

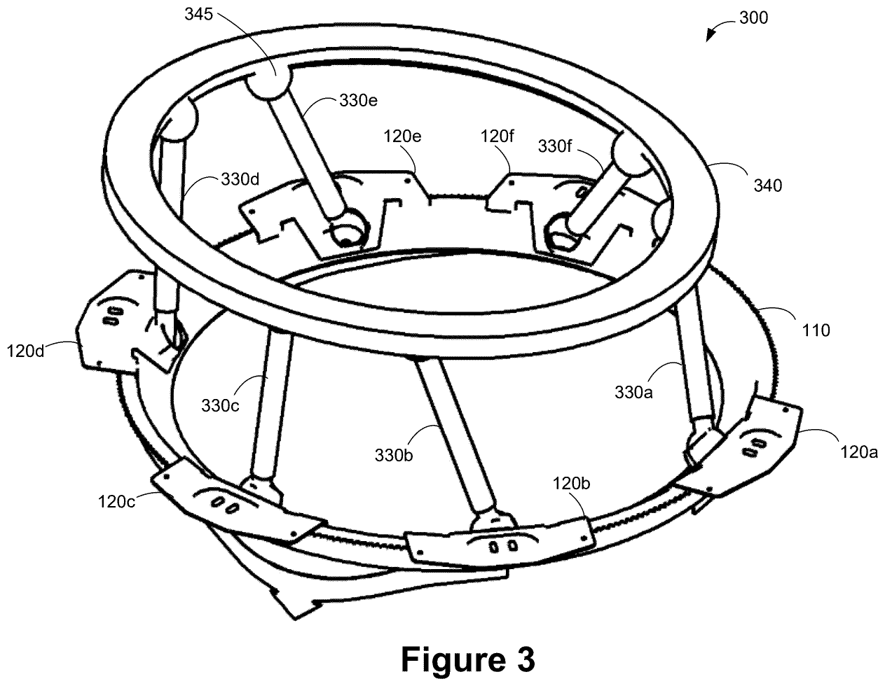

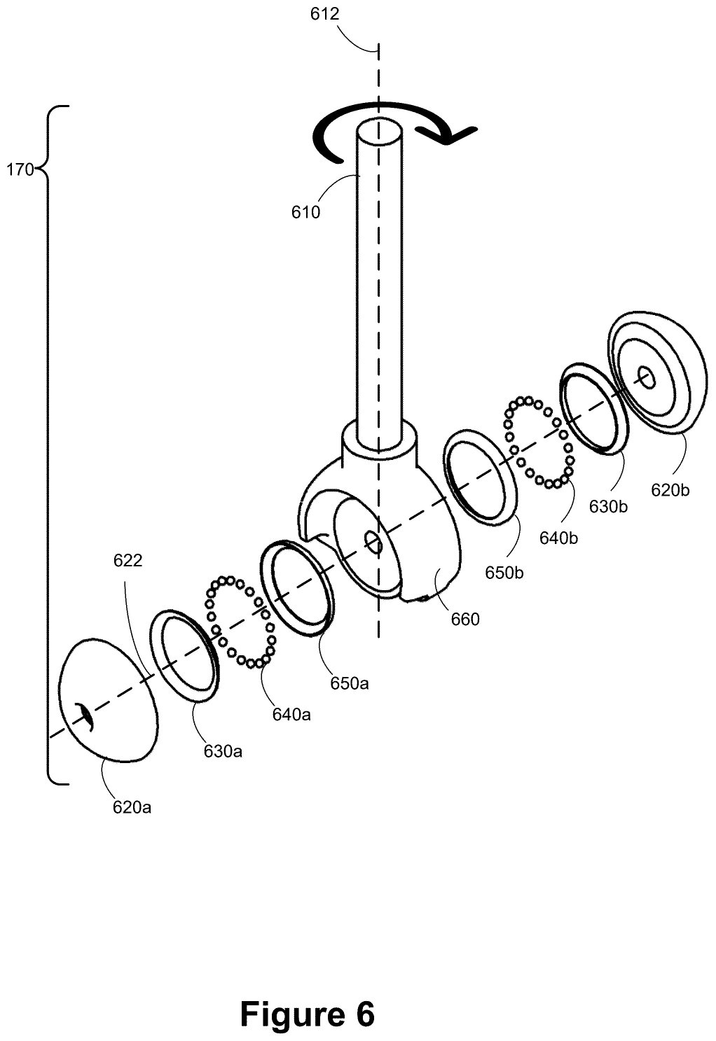

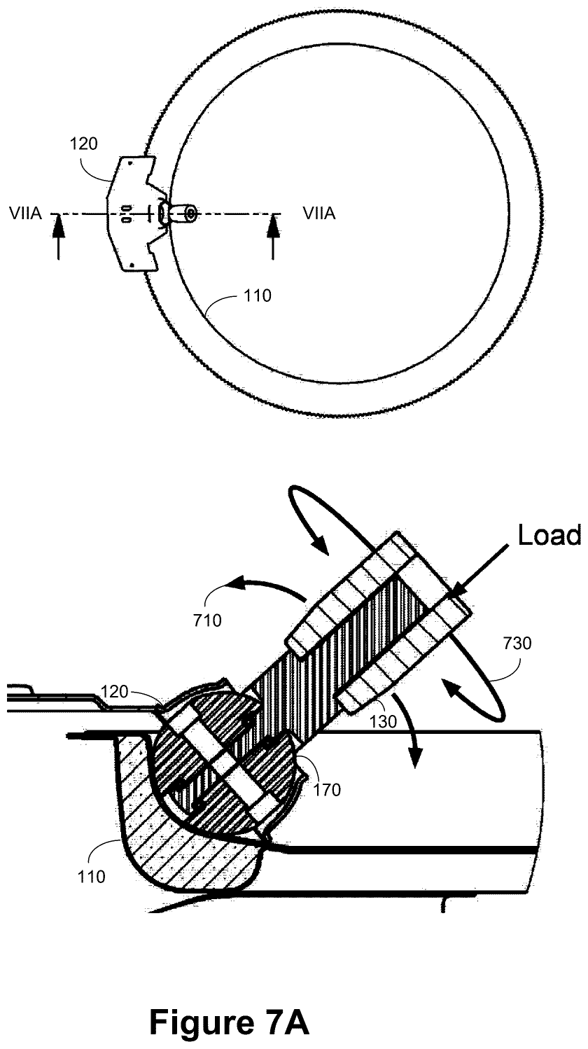

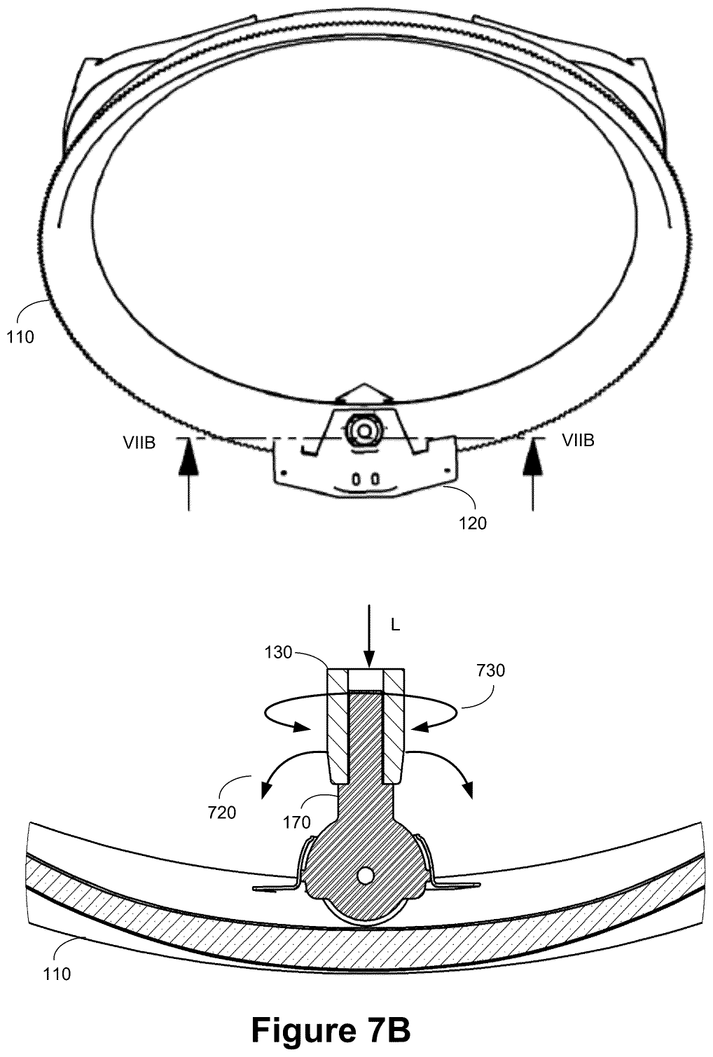

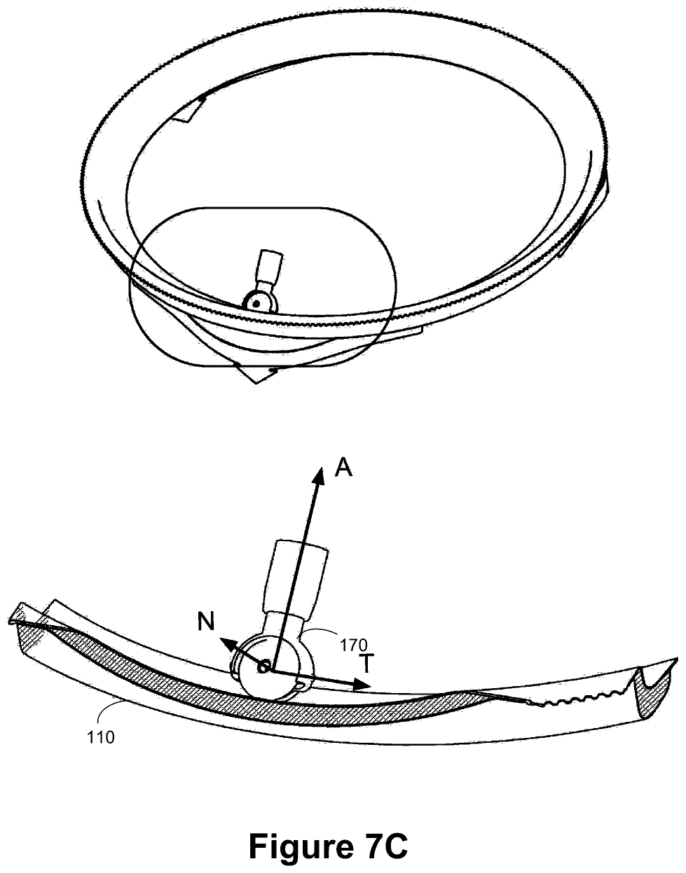

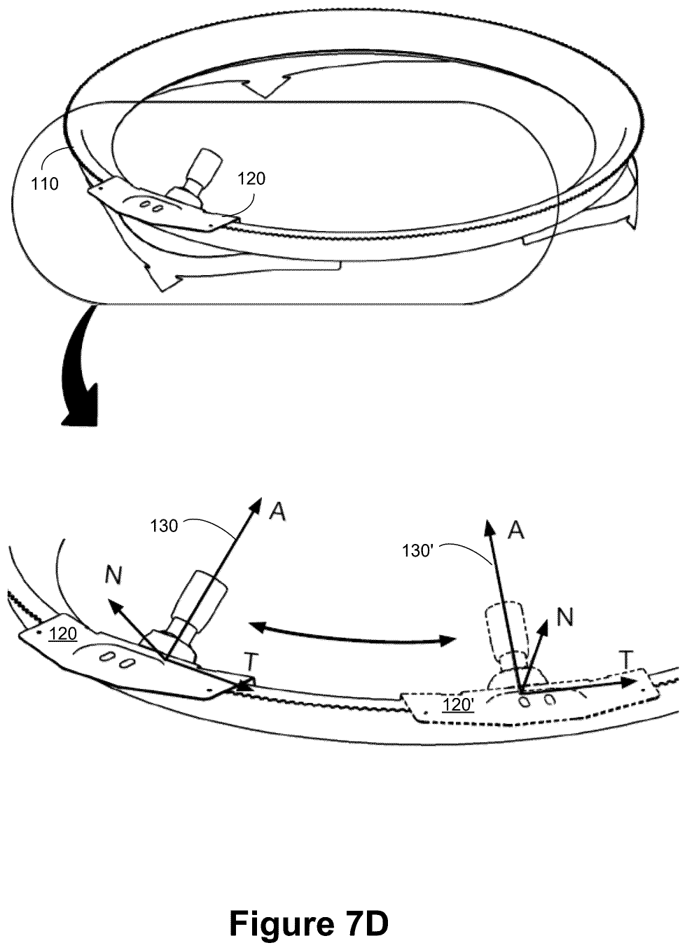

The frame 150 includes a first support member 130a rotatably coupled (e.g., using a ball-and-socket joint or a castor as described with respect to FIGS. 6 and 7A-7C) to the first carriage 120a, a second support member 130b distinct and separate from the first support member 130a and rotatably coupled (e.g., using a ball-and-socket joint or a castor as described with respect to FIGS. 6 and 7A-7C) to the second carriage 120b. The frame 150 also includes a third support member 135 distinct and separate from the first support member 130a and the second support member 130b. In FIG. 1A, the third support member 135 includes a first arm 135a and a second arm 135b. In some embodiments, the apparatus 100 includes a third carriage (e.g., similar to the first carriage 120a or the second carriage 120b, such as the third carriage 120c shown in FIG. 3) to which the third support member 135 is rotatably coupled. However, in FIG. 1A, the third support member 135 is rotatably coupled (e.g., using a ball-and-socket joint or a castor as described with respect to FIGS. 6 and 7A-7C) to the nonlinear rail 110 or a base (which may or may not include the nonlinear rail 110) at location Y (e.g., without a corresponding carriage). In some embodiments, the third support member 135 is rotationally (e.g., pivotally) coupled to the mount 160 (e.g., using one or more pins).

In some embodiments, the nonlinear movements of the first and second carriages 120a and 120b are independent (e.g., the first and second carriages 120a and 120b include separate drive mechanisms so that each carriage can move and be operated individually). In some embodiments, the nonlinear movements of the first and second carriages 120a and 120b are coupled (e.g., the first and second carriages 120a and 120b share a common drive mechanism or receive symmetric drive signals so that the first and second carriages 120a and 120b move by a same distance in opposite directions).

FIG. 1B is a side view of the apparatus 100 in a particular position to illustrate the operations of the apparatus 100. When the first carriage 120a and the second carriage 120b move in opposite directions along the nonlinear rail 110 at the same speed, their displacements relative to location Y are identical (and hence the first carriage 120a is right behind the second carriage 120b in FIG. 1B and their lateral positions in FIG. 1B are indicated with a common label C). As the first and second carriages 120a and 120b move toward location Y, triangle CBY (where C represents a lateral position of the first and second carriages 120a and 120b, location Y represents a location where the third support member 135 is rotationally coupled to the base, and B represents a location where the third support member 135 is rotationally coupled to a center block connecting the first and second support members 130a and 130b to the third member 135) becomes more acute and the rotational joint A (at which the third support member 135 is coupled to the mount 160) elevates, increasing the height of an object mounted on the mount 160.

The frame 150 in FIG. 1B also includes a rotational joint D, which moves in unison with position C. Thus, when the first and second carriages 120a and 120b move toward location Y, the rotational joint D pushes link DE, which in turn rotates the link EFR rotationally coupled to the third support member 135 about location F. This causes the rotational joint R to elevate, thereby increasing the elevation angle of the mount 160 (and the mounted object). Thus, moving the first carriage 120 and the second carriage 120b symmetrically in opposite directions at the same speed causes the vertical translation and rotation of the mount (e.g., changing the elevation angle or pitch angle).

In comparison, moving the first carriage 120 and the second carriage 120b in the same direction (e.g., clockwise or counterclockwise) at the same speed causes the mount to rotate about the zenith axis (e.g., changing the azimuth angle or yaw angle) without changing the height (or the pitch angle) of the mount 160 (and the mounted object).

Therefore, the apparatus 100 converts nonlinear movements of carriages into changes in the elevation, pitch, and azimuth of the mount 160 (and the mounted object).

FIG. 1C shows the apparatus 100 in a configuration where the first and second carriages 120a and 120b have moved symmetrically closer to location Y so that the height and pitch of the mount 160 has changed (e.g., the mount 160 is in a vertical orientation). FIG. 1D shows the apparatus 100 in a configuration where the first and second carriages 120a and 120b have moved symmetrically away from location Y so that the height and pitch of the mount 160 has changed (e.g., the mount 160 is in a nearly horizontal orientation, which may be used for transporting or storing the apparatus 100 and/or the mounted object).

The configuration shown in FIGS. 1A-1D provides several advantages, such as easy access for cleaning and maintenance and uniform load distribution. The configuration shown in FIGS. 1A-ID also maintains the center of gravity of the apparatus substantially centered about the center of the base (or the nonlinear rail), which increases the stability of the apparatus and the mounted object.

FIGS. 1E-1H illustrate a portion of the apparatus 100 shown in Figures IA-1D in accordance with some embodiments. In FIGS. 1E-1H, some of the parts or elements (e.g., the mount 160, the link DE, or the link EFR) shown in FIGS. 1A-1D are omitted to illustrate the movements of the first and second carriages 120a and 120b and the first, second, and third support members, 130a, 130b, and 135.

The basis for the apparatus 100 is rooted in the ability to convert planar circumferential motion of at least one body (e.g., carriage, such as 120a or 120b) along a nonlinear (e.g., circular) guide rail 110 to translation, rotation, or combination thereof, of at least one other body in a three-dimensional space (including a movement or rotation off the plane of circumferential motion). In some embodiments, two or more carriages follow the same path around the nonlinear guide rail, which reduces the size of the apparatus. In operation, the frame of the apparatus 100 converts the angular positions of carriages (along the nonlinear rail) into a zenith and azimuth of a mounted object. In some embodiments, the angular position of each carriage is controlled by a motor-driven actuator in the carriage.

FIG. 1E illustrates a configuration in which the first and second carriages 120a and 120b are positioned close to location Y, thereby raising the height of the third support member 135. FIG. 1F illustrates a configuration in which the first and second carriages 120a and 120b are positioned away from location Y, thereby lowering the height of the third support member 135.

Shown in FIGS. 1G and 1H is a center block 140 (also called a first block) of the apparatus 100 in accordance with some embodiments. In some embodiments, the center block 140 is used to maintain symmetry in the linkage. A symmetry keeping linkage is crucial to constraining the system while supporting the load. This part of the system ensures that the load is generally divided equally between the first and second support members 130a and 130b. It also contributes to the constraints that make the system statically determinate. FIG. 1G shows the symmetry linkage portion of the frame when the first and second carriages 120a and 120b are positioned close to location Y, and FIG. 1H shows the symmetry linkage portion of the frame when the first and second carriages 120a and 120b are positioned away from location Y.

FIG. 1I is an exploded view of the center block 140 of the apparatus 100 shown in FIGS. 1A-1H in accordance with some embodiments. In FIG. 1I, the center block 140 includes a symmetry linkage employing two overlapping straight-line mechanisms which share a common point. The common point slides along the center plane of the frame assembly. The linkage includes two legs 130a and 130b (e.g., the first support member 130a and the second support member 130b) and two plates 141 and 142, where the legs 130a and 130b are held between the plates 141 and 142 like a sandwich. The legs 130a and 130b are joined together with a pin 138 (which may pass through a through-hole 136a defined in the leg 130a and a through-hole 136b defined in the leg 130b) at an overlap section 139, and the pin 138 engages the centerline vertical slots J and M in both of the plates 141 and 142 on the front and back sides of the legs 130a and 130b. Horizontal slots (e.g., H, I, K, and L) engage with pins 132a, 132b, 134a, and 134b in other sections of the legs 130a and 130b. In some configurations, this facilitating the frame to remain oriented parallel to the plane of the nonlinear rail.

FIG. 1I also illustrates casters 170a and 170b, which are coupled to the legs 130a and 130b, respectively (e.g., the caster 170a is rotatably coupled to the leg 130a and the caster 170b is rotatably coupled to the leg 130b). In some configurations, the casters coupled to the symmetry link create half of a statically determinate system within a circular track. The inclusion of a single additional link (e.g., third support member 135) completes the statically determinate linkage on the circular track (e.g., frame CBY). For example, in Figures IB-ID, rotating linkage EFR is driven (e.g., controlled or positioned) by manipulating (e.g., adjusting the configuration or internal angle of) frame CBY (e.g., through coupling link DE). In practice, variations of the configuration shown in this application may be used for body manipulation driven by the main linkage CBY (e.g., a link different from link DE may be used to adjust the orientation of the mount based on the movement of the main linkage CBY).

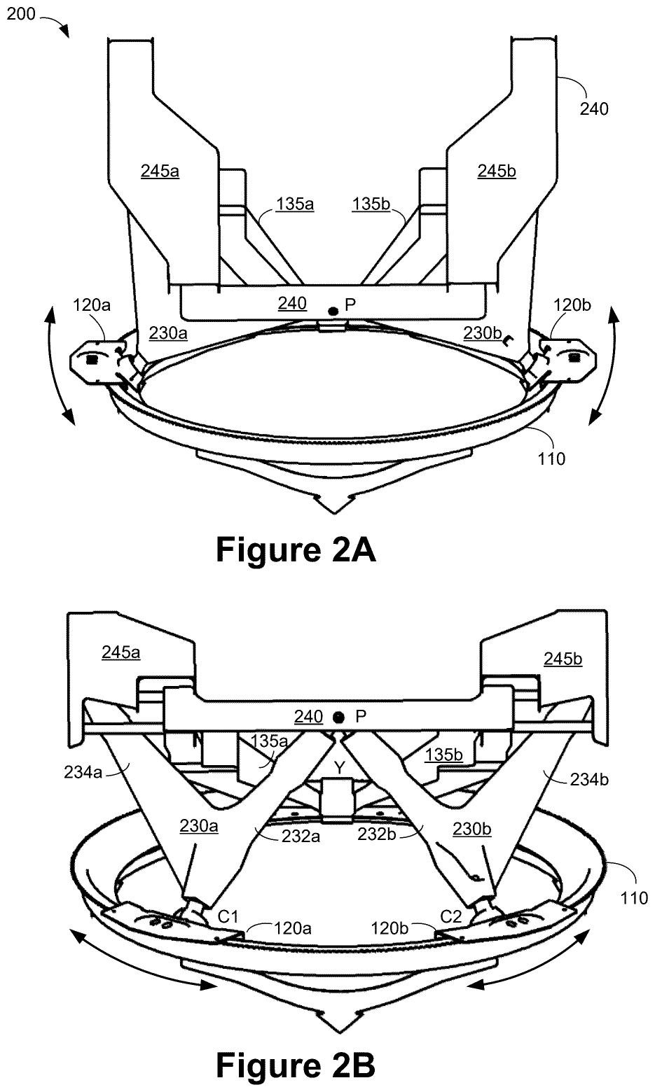

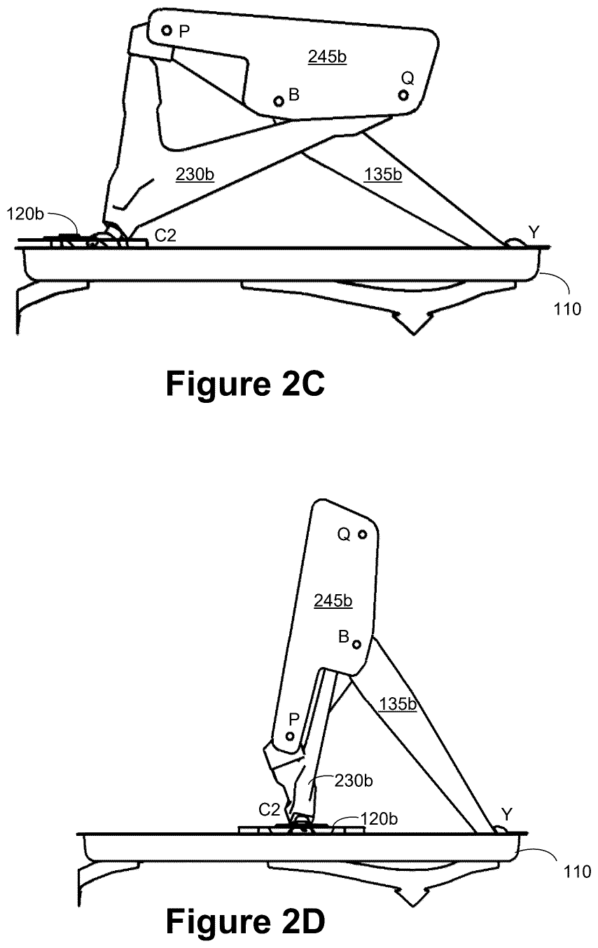

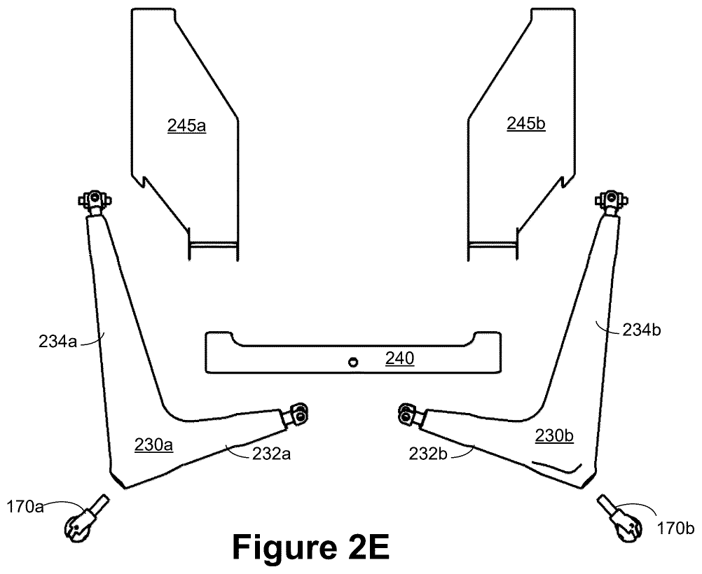

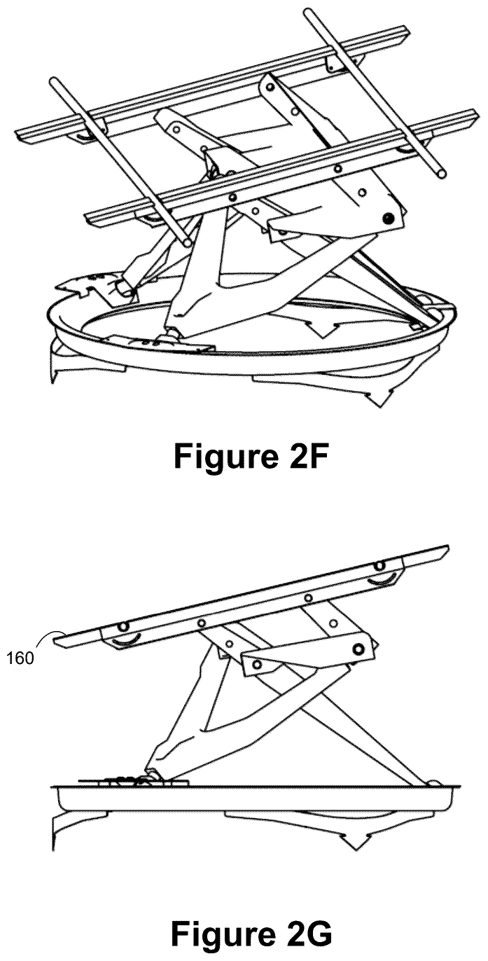

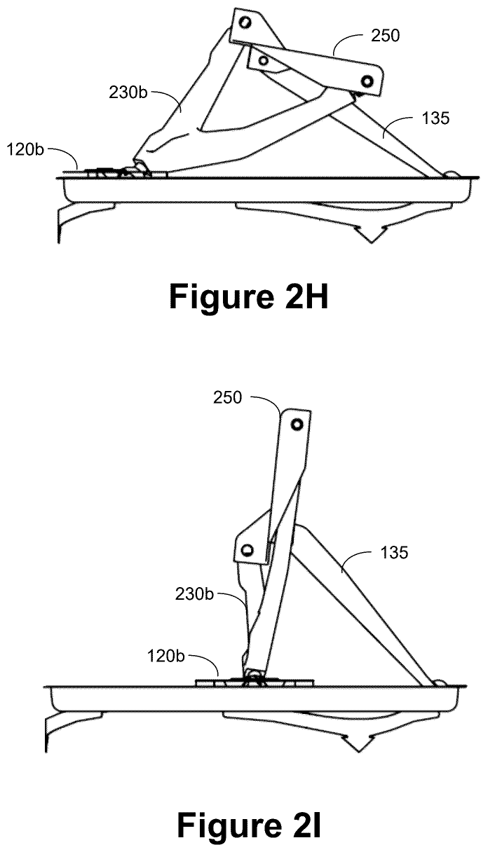

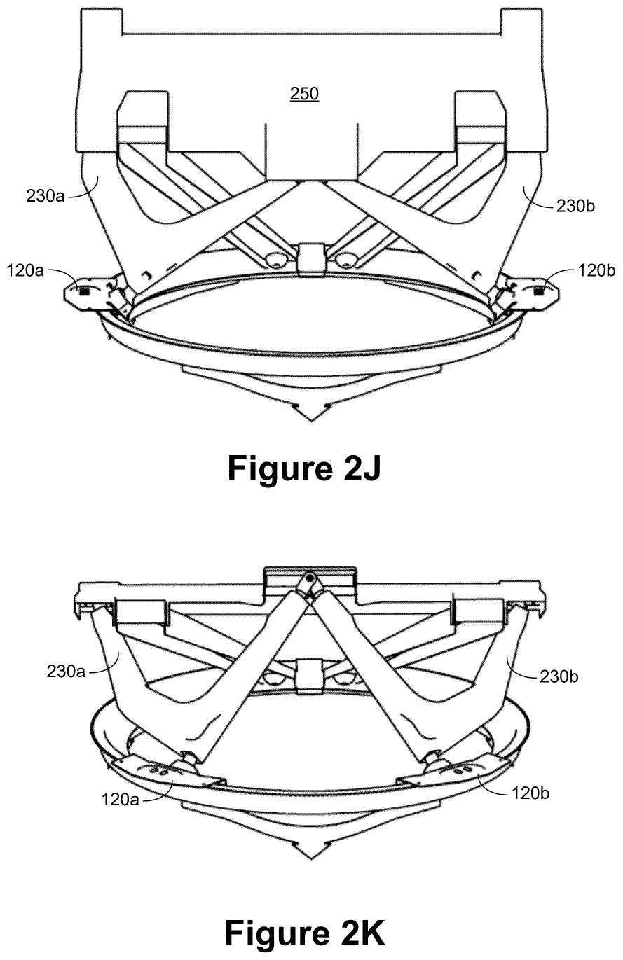

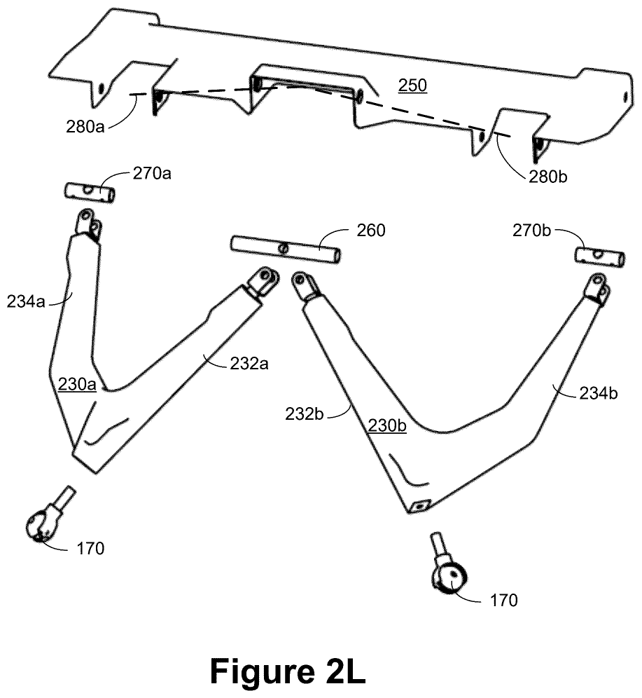

FIGS. 2A-2D illustrate an apparatus 200 for positioning an object in accordance with some embodiments.

The apparatus 200 includes a frame distinct from the frame of the apparatus 100. In the apparatus 200, the frame includes a first block 240, a second block 245a rotatably coupled to a first end of the first block 240, and a third block 245b rotatably coupled with a second end, opposite to the first end, of the first block 240. In some embodiments, the second block 245a is coupled to the first block 240 using a revolute joint, and the third block 245b is coupled to the first block 240 using a revolute joint. A first support member 230a includes a first arm 232a and a second arm 234a distinct from the first arm 232a. A second support member 230b includes a third arm 232b and a fourth arm 234b distinct from the third arm 232b. The first arm 232a and the third arm 232b are rotatably coupled with the first block 240 (at joint P). The second arm 234a is rotatably coupled with the second block 245a. The fourth arm 234b is rotatably coupled with the third block 245b.

The joint P creates a symmetry keeping link between carriages C1 and C2 (the first carriage 120a and the second carriage 120b). FIGS. 2C and 2D are side views of the apparatus 200. FIGS. 2C and 2D show that, as carriages C1 and C2 increase displacement from one another (e.g., carriages C1 and C2 move toward location Y where the third support member is rotationally coupled to the nonlinear rail or base), the joint P moves closer to the plane of the nonlinear rail because of the fixed lengths of 232a and 232b relative to the diameter of the nonlinear rail (e.g. triangle C1-P-C2 becomes less acute). Similarly, as C1 and C2 increase displacement from one another, joint Q increases displacement from the plane of the nonlinear rail because of the fixed lengths of 234a and 234b. This results in rotation of body PBQ about point B (e.g., changing the elevation angle) supplementary to the rotation of body PBQ from the manipulation of triangle CBY. In addition, as C approaches location Y, joint B elevates relative to the plane of the nonlinear rail. As a result, moving the carriage C toward location Y causes body PBQ to concurrently elevate and rotate (e.g., pitch).

FIG. 2E is an exploded view of a center block of the apparatus shown in FIGS. 2A-2D in accordance with some embodiments.

The center block includes the first block 240, the second block 245a rotatably coupled with the first block 240, and the third block 245b rotatably coupled with the first block 240.

As described above, the first support member 230a has the first arm 232a and the second arm 234a. The second support member 230a has the third arm 232b and the fourth arm 234b. The end of a respective arm of the first, second, third, and fourth arms 232a, 234a, 232b, and 234b includes a rotational joint.

Although a mount for supporting an object is not shown in FIGS. 2A-2D so as not to obscure other aspects of the apparatus 200, a mount may be coupled with any combination of the first block 240, the second block 245a, or the third block 245b in a manner analogous to the coupling of the mount 160 in the apparatus 100.

FIG. 2E also illustrates casters 170a and 170b, which are coupled to the first support member 230a and the second support member 230b, respectively (e.g., the caster 170a is rotatably coupled to the first support member 230a and the caster 170b is rotatably coupled to the second support member 230b).

FIGS. 2F-2K illustrate an apparatus for positioning an object in accordance with some embodiments. The apparatus illustrated in FIGS. 2F-2K is similar to the apparatus illustrated in FIGS. 2A-2D except that the apparatus illustrated in FIGS. 2F-2K includes a single block instead of a combination of three blocks rotatably coupled with one another (e.g., the first block 240, the second block 245a, and the third block 245b as shown in FIG. 2E).

FIGS. 2F (a perspective view) and 2G (a side view) show the apparatus with the mount 160.

FIGS. 2H-2K show a portion of the apparatus shown in FIGS. 2F and 2G. FIGS. 2H and 21 show side views of the apparatus with different positions of the carriage 120b (and the carriage 120a which is located behind the carriage 120b in FIGS. 2H and 21). FIGS. 2J and 2K are perspective view of the apparatus with different positions of the carriages 120a and 120b). In FIGS. 2H-2K, some of the parts or elements (e.g., the mount 160 or links) shown in FIGS. 2F and 2G are omitted to illustrate the movements of the first and second carriages 120a and 120b and the first, second, and third support members, 230a, 230b, and 135 without obstruction.

FIG. 2L is an exploded view of a center block 250 of the apparatus shown in FIGS. 2F-2K in accordance with some embodiments. As shown in FIG. 2L, the center block 250 is rotatably coupled with the first support member 230a and the second support member 230b. FIG. 2L shows that both arms of the first support member 230 are rotatably coupled with the center block 250 (e.g., each of the first arm 232a and the second arm 234a of the first support member 230a is rotatably coupled with the center block 250 and each of the third arm 232b and the fourth arm 234b of the second support member 230b is rotatably coupled with the center block 250). In some embodiments, as shown in FIG. 2L, the first support member 230a is rotatable with respect to the center block 250 about a first rotational axis 280a and the second support member 230b is rotatable with respect to the center block 250 about a second rotational axis 280b that is non-parallel to the first rotational axis 280a.

In some embodiments, the first arm 232a and the third arm 232b are rotatably coupled with the center block 250 using a pin 260. In some embodiments, the second arm 234a is rotatably coupled with the center block 250 using a pin 270a. In some embodiments, the fourth arm 234b is rotatably coupled with the center block 250 using a pin 270b. In some embodiments, universal joints are for coupling a respective arm to a corresponding pin.

FIG. 3 illustrates an apparatus 300 for positioning an object in accordance with some embodiments.

The apparatus 300 includes additional carriages (e.g., three or more carriages), which provides higher degrees of freedom. In some embodiments, the linkage assembly adheres to Kurtzbach criterion of constraints and mobility. The apparatus 300 shown in FIG. 3 has 6 degrees of freedom, similar to what is commonly called spatial frame. The apparatus 300 uses the planar circular motion of the carriages in place of linear actuation in typical spatial frames. One advantage of the apparatus 300 over traditional spatial frames is that the output plane can revolve indefinitely relative to the base.

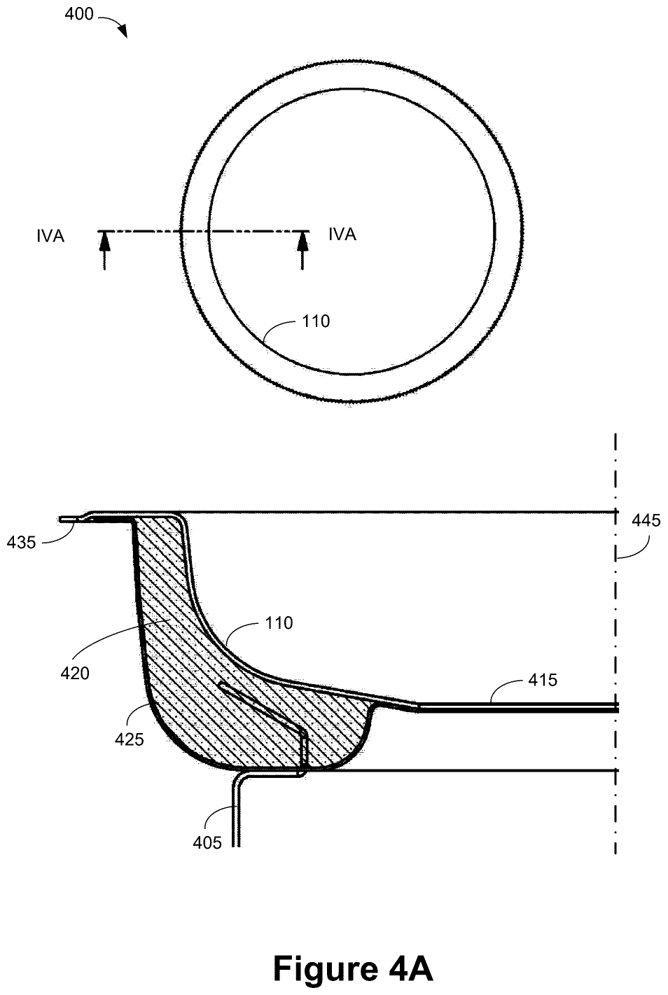

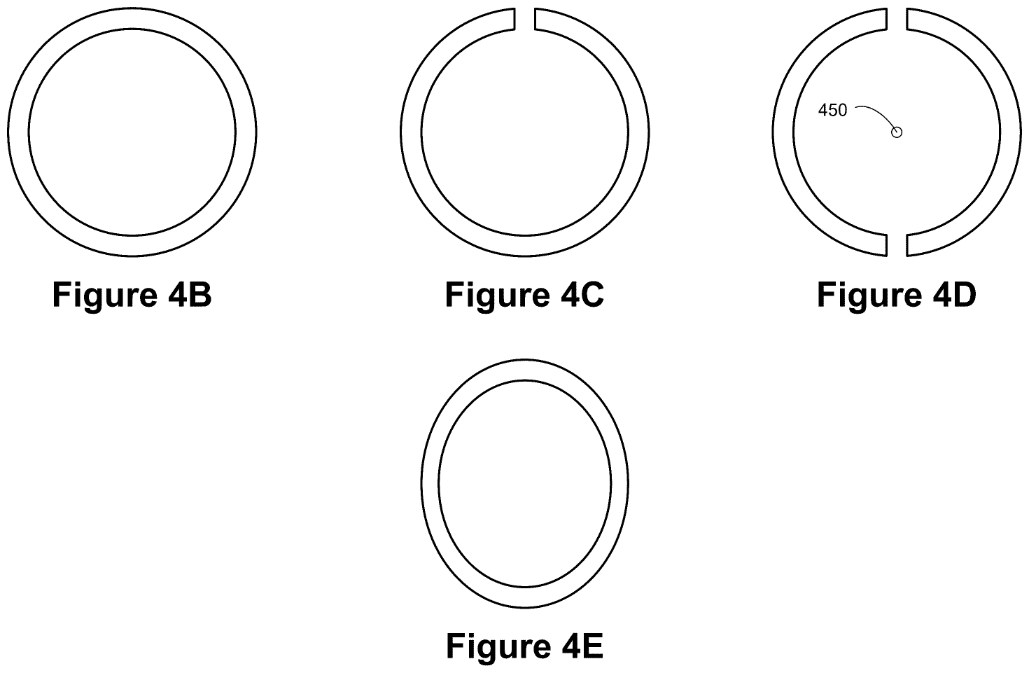

FIG. 4A illustrates a base 400 in accordance with some embodiments. As shown in the top portion of FIG. 4A, which is a plan view of the base 400, in some embodiments, the base 400 includes a first portion (e.g., an inner portion, a lower portion, etc.) with a nonlinear rail track 110. The top portion of FIG. 4A also shows line IVA from which a cross-sectional view shown in the bottom portion of FIG. 4A is taken. As shown in the bottom portion of FIG. 4A, in some embodiments, the base 400 includes a second portion (e.g., an outer portion, an upper portion, etc.) with a lip 435. In some embodiments, the base 400 has a rotational symmetry about an axis 445 of rotation (e.g., the base 400 has a circular shape). In some embodiments, the base 400 includes a top plate 415 and a bottom plate 425 and a filler 420. In some embodiments, the top plate 415 and the bottom plate 425 include metal. In some embodiments, the filler 420 includes cement, concrete, or asphalt. The combination of metal plates 415 and 425 with the filler 420 simplifies manufacturing of the base 400. For example, instead of carrying a single heavy-weight base to an installation site, the top plate 415, the bottom plate 425, and the filler 420 may be transported separately to the installation site and combined for installation. In addition, the combination of metal plates 415 and 425 with the filler 420 increases the mechanical strength and durability of the base 420. In some embodiments, the base 400 further includes one or more feet 405. In some configurations, the one or more feet 405 position the rest of the base 400 above the ground. In some other configurations, the one or more feet 405 are embedded in the soil to prevent a lateral movement of the base 400 (and the entire apparatus supported by the base 400).

FIGS. 4B-4E are schematic diagrams illustrating plan views of the base 400 in accordance with some embodiments. FIG. 4B illustrates that the base 400 defines a closed circular rail. FIG. 4C illustrates that the base 400 defines a non-closed (e.g., open) circular rail. FIG. 4D illustrates that the base 400 defines, or includes, two or more nonlinear rails (e.g., two or more rails corresponding to two or more arcs of a circle). In some embodiments, the two or more nonlinear rails have a common center of curvature 450. In some embodiments, the two or more nonlinear rails are convex rails (e.g., rails bulging outwardly like portions of a circle, ellipse, or oval). FIG. 4E illustrates that the base 400 defines a closed non-circular (e.g., elliptical) rail. Similar to FIGS. 4C and 4D, in some embodiments, the base 400 defines a non-closed (e.g., open) non-circular (e.g., elliptical) rail, and in some embodiments, the base 400 defines two or more non-circular nonlinear rails (e.g., two or more rails corresponding to two or more arcs of an ellipse).

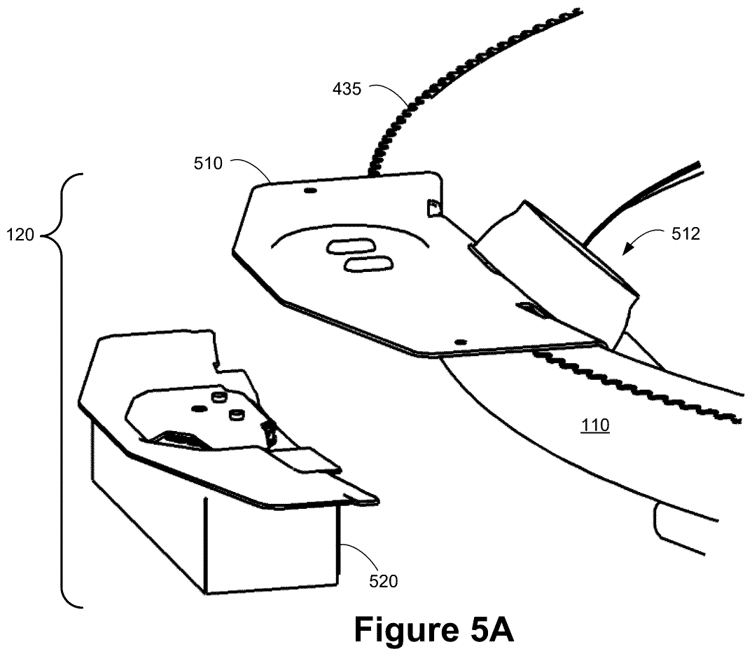

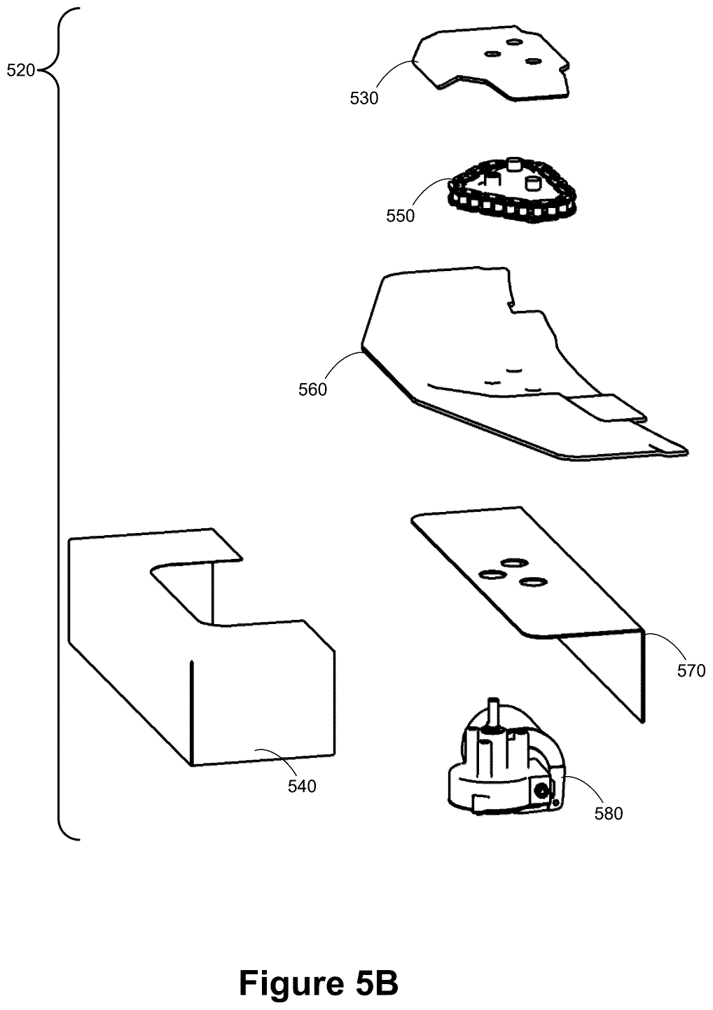

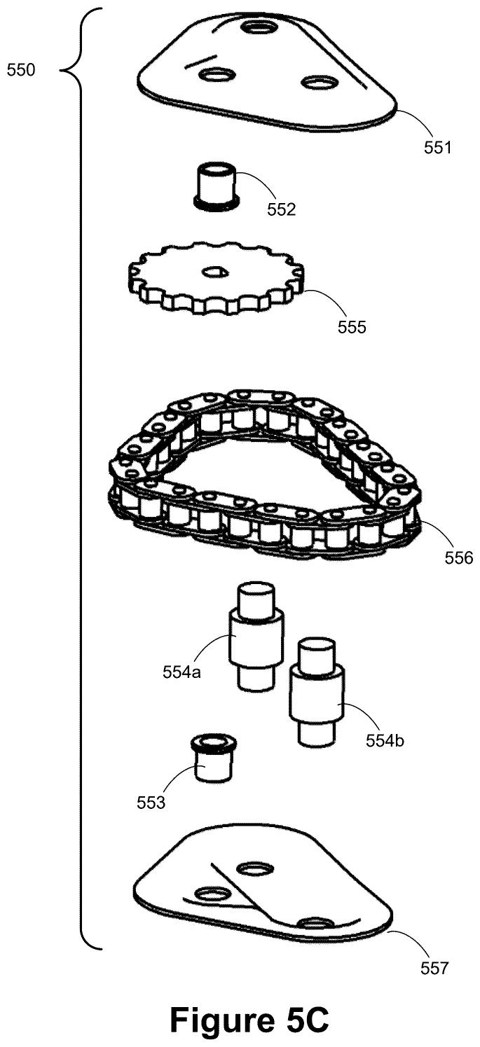

Referring back to FIG. 4A, FIG. 4A illustrates that the lip 435 is a portion of the top plate 415 in accordance with some embodiments. However, in some other embodiments, the lip 435 is a portion of the bottom plate 425. In yet some other embodiments, the lip 435 includes a portion of the top plate 415 and a portion of the bottom plate 425. In some embodiments, the lip 435 includes gear teeth as illustrated in FIG. 5A. In some embodiments, the gear teeth are located facing outwards on the lip 435 as shown in FIG. 5A. In some embodiments, the gear teeth are located facing inwards on the lip 435.

FIGS. 5A-5C illustrate parts of a carriage 120 in accordance with some embodiments.

FIG. 5A shows that the carriage 120 includes, or is coupled with, a drive actuator 520 (e.g., in some embodiments, the carriage 120 includes a carriage plate 510, which is coupled with the drive actuator 520). In configurations where the base (e.g., the lip 435 of the base) has gear teeth, the drive actuator 520 engage with the gear teeth to provide a lateral movement. For example, in some embodiments, the drive actuator 520 includes a sprocket driven chain. The chain may act as an intermediary for power transmission between two adjacent coplanar gear forms. Alternatively, a spur style gear may be used for power transmission. However, the use of a chain improves the durability in outdoor conditions and reduces the cost to manufacture. When used with the lip 435 having gear teeth, the chain provides additional advantages, including reduction or elimination of the backlash interface between the drive gear and the nonlinear rail.

FIG. 5B is an exploded view showing parts of the drive actuator 520 in accordance with some embodiments. FIG. 5B shows that the drive actuator 520 includes a drive actuator housing 540, a driver motor 580, and a sprocket-chain assembly 550. The driver motor 580 is coupled with the sprocket-chain assembly 550 to drive (e.g., rotate) a gear (e.g., a sprocket) in the sprocket-chain assembly. In some embodiments, the drive actuator 520 also includes one or more plates, such as plates 530, 560, and 570 for holding or coupling other components of the drive actuator 520 (e.g., the driver motor 580 or the sprocket-chain assembly 550).

FIG. 5C is an exploded view showing parts of the sprocket-chain assembly 550. FIG. 5C shows that the sprocket-chain assembly 550 includes a sprocket 555 and a chain 556 engaged with the sprocket 555 so that the rotation of the sprocket 555 drives (e.g., rotates or pulls) the chain 556. In some embodiments, the sprocket-chain assembly 550 also includes one or more plates (e.g., plates 551 and 552) for holding or coupling other components of the sprocket-chain assembly 550. In some embodiments, the sprocket-chain assembly 550 includes one or more pins or shafts 552 and 553 for rotatably coupling the sprocket 555 to one or more other parts of the sprocket-chain assembly 550 (e.g., plate 551 or plate 552). In some embodiments, the sprocket-chain assembly 550 includes one or more additional gears or wheels (e.g., rotatable wheels 554a and 554b) for positioning the chain 556.

In some embodiments, the driver motor 580, the sprocket 555, the gear teeth of the lip 435, and the chain 556 are sized accordingly with the load (e.g., the weight of the object). For example, the chain engagement may be increased for tooth loads on the nonlinear rail.

In some configurations, the use of a chain drive system for interfacing with the base ring results in nearly zero backlash. Traversing around the base circumference yields maximum mechanical advantage and overall system accuracy. The circumferential drive configuration in combination with the chain coupling permits using an off-the-shelf low cost DC gear motor, which limits backlash, while providing high accuracy in positioning the payload. The drive assemblies move the carriages by engaging with teeth around the circumference of the base (e.g., FIG. 5A). The drives use a simple robust chain assembly including a chain guide, drive sprocket and supporting chassis (FIGS. 5B and 5C). In some embodiments, the chain guide and chassis are complex die-formed parts. In some embodiments, the entire assembly is self-tensioning; as the drive mounts onto the carriage, the chain takes the shape of the base ring circumference, and the chain is pulled into tension. This chain engagement frequently results in zero backlash between the drive and the base ring.

Referring back to FIG. 5A, in some embodiments, the top plate 510 of the carriage 120 defines a hole 512 for allowing a support member (e.g., the first support member 120a or the second support member 120b) to apply the load directly onto the nonlinear rail 110 instead of onto the carriage 120. In some embodiments, the support member includes, or is coupled with, a wheel (e.g., a caster 170), which remains in contact with the nonlinear rail 110 in operation.

FIG. 6 is an exploded view of the caster 170 in accordance with some embodiments.

FIG. 6 shows that the caster 170 includes a caster body 660 and wheels 620a and 620b rotatably coupled with the caster body 660. In some embodiments, the caster 170 includes one or more bearings (e.g., a first ball bearing with balls 640a located between rings 630a and 650a and a second ball bearing with balls 640b located between rings 630b and 650b, although other types of bearings, such as roller bearings, may be used). For example, in some embodiments, the wheel 620a is rotatably coupled with the caster body 660 using a first bearing (e.g., a first wheel bearing) and the wheel 620b is rotatably coupled with the caster body 660 using a second bearing (e.g., a second wheel bearing) distinct and separate from the first bearing.

In some embodiments, the caster 170 is rotatable about a caster body axis 612. In FIG. 6, the caster body axis 612 is perpendicular to a wheel axis 622 (e.g., an axis of the wheel axle). For example, FIG. 6 shows that the caster 170 includes, or is coupled with, a caster shaft 610, which extends along the caster body axis 612. The caster shaft 610 is rotationally coupled with a support member, thereby allowing the caster 170 to rotate relative to the support member. For example, in some embodiments, the caster shaft 610 is part of a pivot joint rotatably coupling the caster 170 and the support member. In some embodiments, the caster 170 is rotatably coupled with the support member using a swivel.

In some embodiments, the one or more wheels 620a and 620b collectively have a substantially spherical shape. For example, in some embodiments, each of the wheel 620a and the wheel 620b has a shape of a portion of a sphere (e.g., a substantially hemispherical shape) so that the wheel 620a and the wheel 620b, when coupled with the caster body 660, collectively have a substantially spherical shape.

These wheels transfer loads (e.g., the weight of the object and the frame) directly onto the nonlinear rail or the base. Using the spherically-shaped caster assembly, the carriages traverse around the inside of the nonlinear guide ring base. The cross-sectional shape of the base is shaped to receive the spherically shaped wheels. The base supports the wheels directly and the wheels support the frame directly. This reduces or eliminates transfer of the load through the carriages, which would be typical in a carriage-rail system. The spherical shape allows the wheels to pivot freely so that they are always aligned with the forces acting on them from the frame load. In some embodiments, the spherically shaped housing (e.g., the caster body 660) for the wheels allows freedom of motion around two axes only (e.g., rotations 710 and 720), the third axis is constrained so that the wheels 170 are always aligned with the guide rail 110, while member 130 allows for rotation about axis 612 (e.g., rotation 730). FIGS. 7A-7D illustrate the forces on a wheel and a guide rail, showing the allowed freedom of motion.

FIGS. 7A and 7B illustrate the rotational movements of the caster 170. The top portion of FIG. 7A shows a plan view of the guide rail 110 and the carriage 120. The top portion of FIG. 7A also shows line VIIA along which a partial cross-sectional view shown in the bottom portion of FIG. 7A is taken. The top portion of FIG. 7B shows a perspective view of the guide rail 110 and the carriage 120. The top portion of FIG. 7B also shows line VIIB along which a partial cross-sectional view shown in the bottom portion of FIG. 7B is taken. In FIGS. 7A and 7B, other components, such as support members or linkage, are omitted so as not to obscure other aspects of the guide rail 110 and the carriage 120.

In addition, FIGS. 7A and 7B also show that the load L is applied to along the direction of the caster body axis.

FIG. 7C illustrates the guide rail 110 and the caster 170 in accordance with some embodiments. As shown in FIG. 7C, three orthogonal axes (N, A, and T) originating from the center of the spherically shaped wheels, aligned with the axle. The N-axis is perpendicular to a curvature of the nonlinear rail (e.g., base ring). Load from the frame is aligned with the A-axis. Force from the carriages is applied along the T-axis, resulting in translation of the rollers. The frame (or the support member) is allowed to rotate about the A-axis and pivot about N-axis so that the N-axis remains to be perpendicular to the guide rail. The top portion of FIG. 7D highlights a region of the guide rail 110, an enlarged view of which is shown in the bottom portion of FIG. 7D. The bottom portion of FIG. 7D shows that the N-axis remains perpendicular to the guide rail even with the movement of the carriage 120 (e.g., from 120 to 120′).

Although FIGS. 7A-7D illustrate only a single carriage, namely carriage 120, a person having ordinary skill in the art would understand that the guide rail 110 may be coupled with multiple carriages, which are configured (and operate) in a similar manner as the carriage 120 described with respect to FIGS. 7A-7D.

### Example Applications

As described above, the apparatus described herein may be used as a mount (e.g., a tracking mount) for various objects (e.g., a photovoltaic panel, a solar reflector, etc.), an end effector in robotic systems or surgical tools, for example.

For application as a heliostat, the tracking payload will be a high quality mirror built for maximum reflectivity and long life. The large circular base provides several benefits, such as accelerated (single step) field installation with lower heavy machinery cost, high accuracy from low precision parts, low bulk material cost, and fundamental fabrication procedures.

In some configurations, the base ring is designed around a concrete filled steel construction method. Concrete-Steel composites are widely studied in structural applications, most used (in terms of volume) and the least expensive since (two cheapest building materials). Being a composite, the concrete fill reduces the bulk steel required, while also enhancing its strength. The concrete also acts as a binder for adding additional steel parts without welding. The steel parts create precise shapes while the concrete adds rigidity and reduces material and assembly costs.

The apparatus described herein, when used as a tracker, can be installed without ground preparation, while boasting a more stable load distribution to supporting points on the structure, which in turn makes the design scalable and affordable.

The mounted object (e.g., a mirror) can be stowed close to the ground, and the entire structure can be delivered to a site pre-assembled (or nearly fully assembled).

The design is simple but covers a wide range of angles.

The apparatus described herein can benefit other applications beyond heliostat fields, such as a base for assembly line robotics and two axis photovoltaic (PV) trackers.

In some configurations, a low-cost, off-the-shelf gear motor with a common encoder is used. Positioning feedback comes (externally) from the target and allows precise motion control from motor feedback, target feedback and accelerometer feedback onboard the control circuitry.

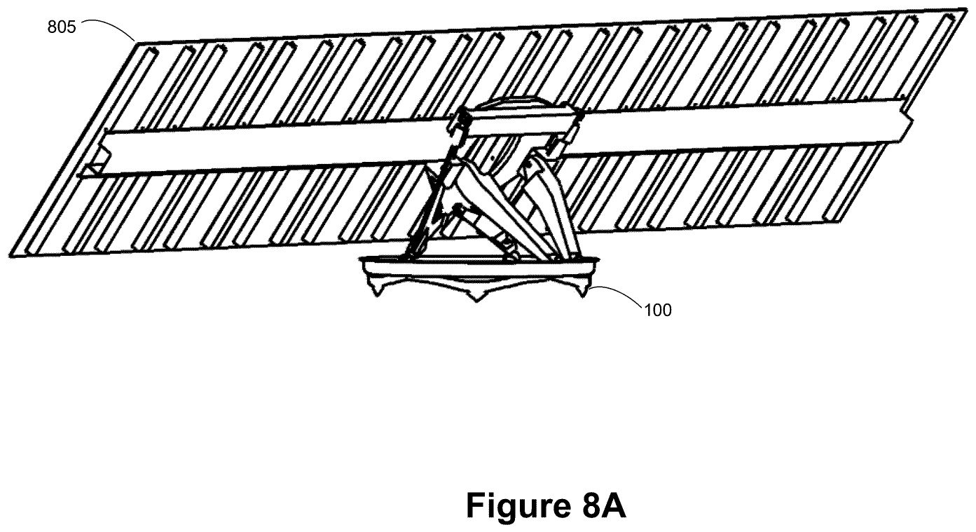

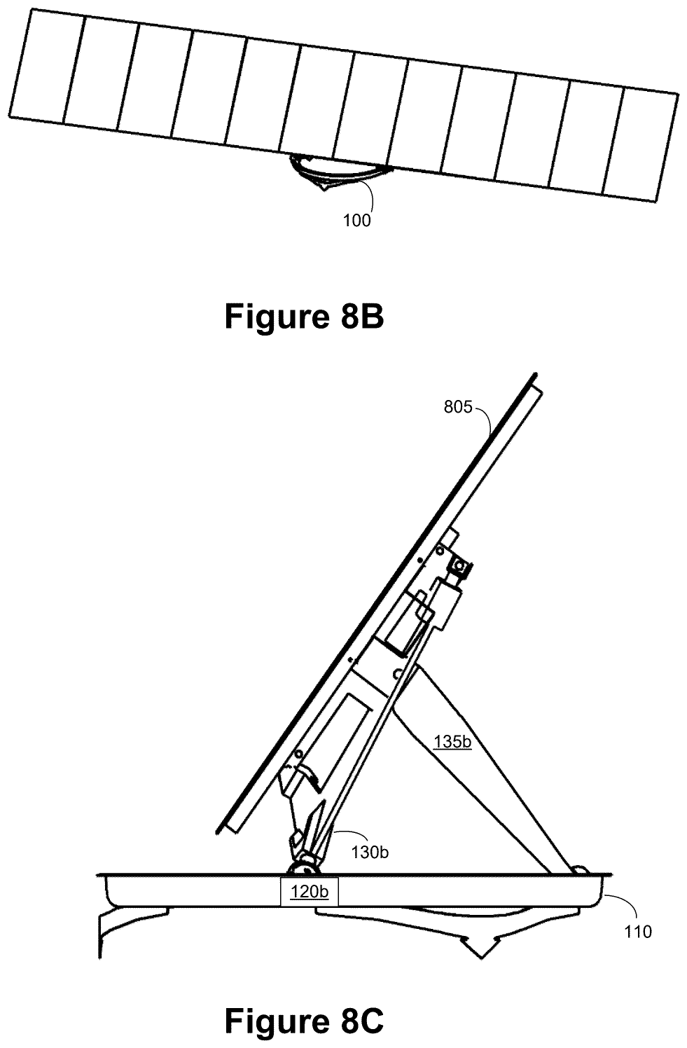

In some configurations, the frame is adapted to carry an array of photovoltaic panels. FIGS. 8A-8C illustrate a payload (e.g., photovoltaic panel 805) mounted on a positioning apparatus in accordance with some embodiments.

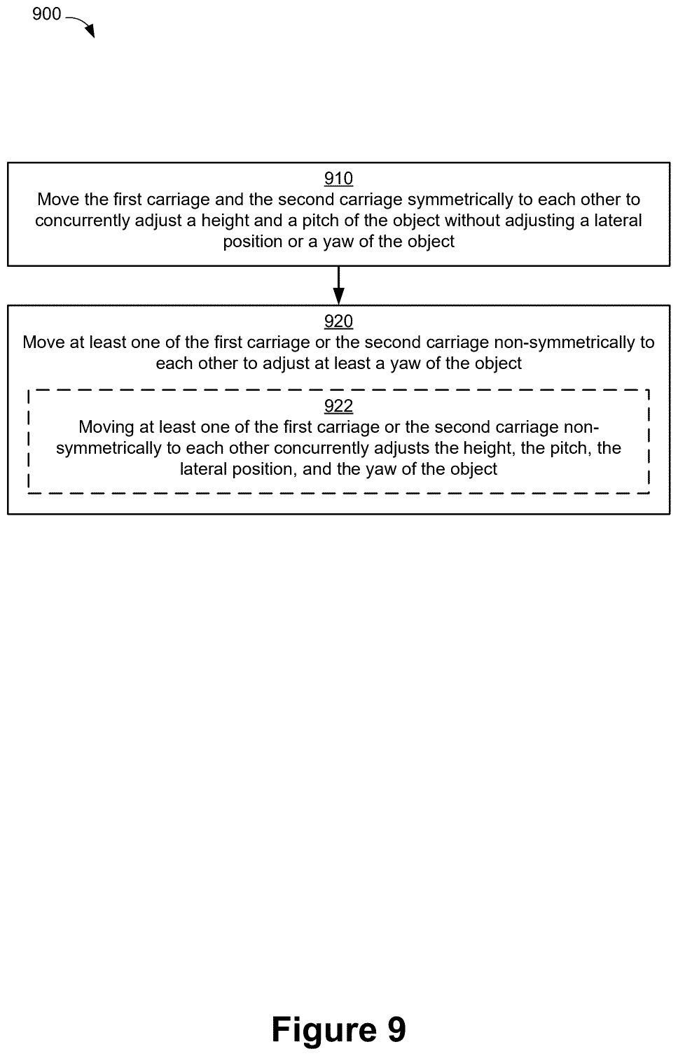

FIG. 9 is a flow diagram illustrating a method 900 of operating a positioning apparatus in accordance with some embodiments. The method 900 is performed by a controller (e.g., controller 190).

The method 900 includes (910) moving the first carriage (e.g., first carriage 120a) and the second carriage (e.g., second carriage 120b) symmetrically to each other to concurrently adjust a height and a pitch of the object without adjusting a lateral position or a yaw of the object (e.g., FIGS. 1C and 1D).

The method 900 also includes (920) moving at least one of the first carriage (e.g., first carriage 120a) or the second carriage (e.g., second carriage 120b) non-symmetrically to each other to concurrently adjust at least a lateral position and a yaw of the object (e.g., moving both the first carriage 120a and the second carriage 120b by the same distance in the same direction rotates the object laterally and also changes the lateral position of the object, without adjusting a height and a pitch of the object).

In some embodiments, moving at least one of the first carriage or the second carriage non-symmetrically to each other concurrently adjusts the height, the pitch, the lateral position, and the yaw of the object. For example, moving only one of the first carriage or the second carriage changes the height, the pitch, the lateral position, and the yaw of the object.

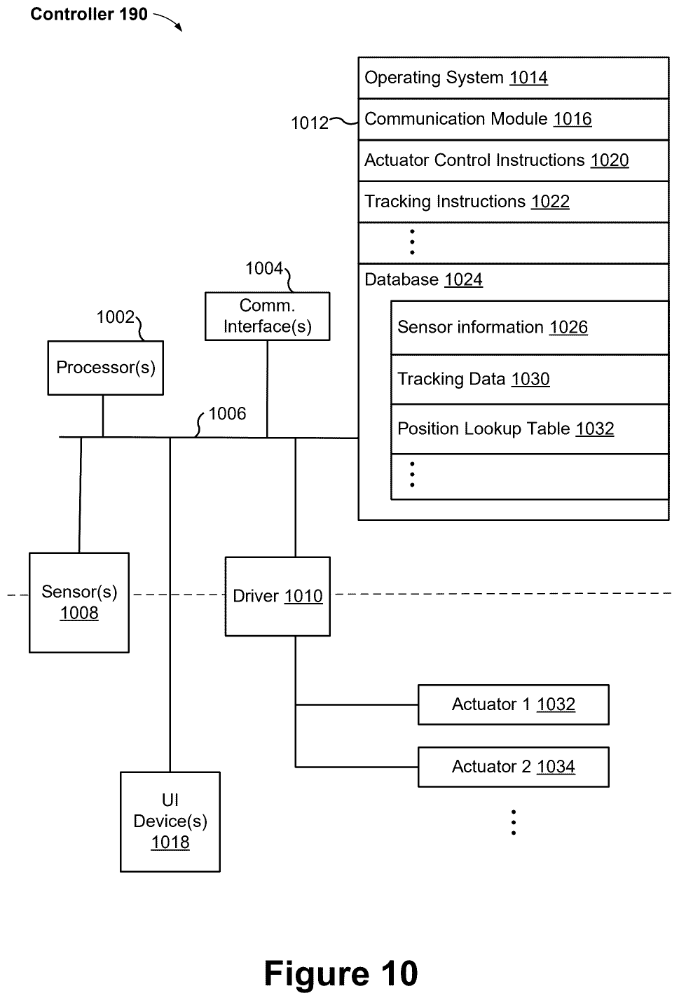

FIG. 10 is a block diagram illustrating electronic components of a positioning apparatus in accordance with some embodiments.

The positioning apparatus includes one or more processors 1002 (central processing units, application processing units, application-specific integrated circuit, etc.), which are in communication (e.g., via one or more communication buses 208 interconnecting a plurality of electronic components of the positioning apparatus) with a computer-readable storage medium 1012 (e.g., transitory computer readable storage medium or non-transitory computer memory devices, such as random-access memory, read-only memory, static random-access memory, and other non-volatile memory, and other storage devices, such as a hard drive, an optical disk, a magnetic tape recording, or any combination thereof) storing instructions for performing any methods described herein (e.g., operations described with respect to FIG. 9). For example, in some embodiments, the computer-readable storage medium 1012 stores the following programs, modules, instructions, and data structures, or a subset thereof:
operating system 1014 that includes procedures for handling various basic system services and for performing hardware dependent tasks;
communication module (or instructions) 1016 that is used for connecting controller 190 to other electronic devices via one or more communications interfaces 1004 and one or more communications networks (e.g., wired and/or wireless communication networks);
actuator control instructions 1020 that causes electrical signals to be provided to one or more actuators (directly from the one or more processors 1002 or through a driver 1010); and
tracking instructions 1022 for adjusting the position or configuration of the positioning apparatus for a target object (e.g., the Sun).

In some embodiments, the positioning apparatus includes the one or more communication interfaces 1004 for communicating with other electronic devices.

In some embodiments, the controller 190 includes, or is electrically coupled with, one or more drivers 1010 (via a system bus or any suitable electrical circuit). In some embodiments, the one or more drivers 1010 receives instructions and/or data from the one or more processors 1002 and relays the instructions and/or electrical signals to one or more actuators, such as the first actuator 1032 (e.g., in the first carriage 102a), the second actuator 1034 (e.g., in the second carriage 102b), etc.

In some embodiments, the controller 190 includes, or is electrically coupled with, one or more sensors 1008. In some embodiments, the one or more sensors 1008 include one or more position sensors to determine positions of carriages or links. In some embodiments, each carriage includes one or more position sensors. In some embodiments, a plurality of sensors is distributed along the nonlinear rail to determine positions of the carriages. In some embodiments, the one or more sensors include one or more thermal or optical sensors for determining a location of a target object (e.g., the Sun). In some embodiments, the one or more sensors include one or more remote sensors for providing information identifying a location or direction of reflected sunlight. Alternatively, the controller 190 may receive the information identifying the location or direction of the reflected sunlight through the one or more communication interfaces 1004.

In some embodiments, the controller 190 includes, or is in communication with, one or more user interface (UI) devices 1018. In some embodiments, the UI devices 1018 include one or more user input devices (e.g., a keyboard, a mouse, a touch-sensitive surface, buttons, switches, etc.) for receiving user inputs (e.g., a request to change a position of the mount) and one or more output devices (e.g., a display, one or more indicators, an audio device, etc.) for providing an output to the user (e.g., a status of a position-changing operation, a position of the mount or the mounted object).

In some embodiments, the computer-readable storage medium 1012 also includes the following, or a subset thereof:
sensor information 1026, which includes information received from one or more sensors 1008;
tracking data 1028, which includes information identifying positions of a target object (e.g., the Sun) at different time points; and
position lookup table 1030, which includes information identifying positions of carriages corresponding to a particular position (e.g., height, lateral position, and angular positions) of the mount or a mounted object.

Although FIG. 10 shows that there is one controller 190 (e.g., one actuator controller for the entire positioning apparatus), in some embodiments, the positioning apparatus includes additional controllers (e.g., one controller for each actuator, etc.). In some embodiments, the one or more processors 1002 are in communication with one or more user interface devices (e.g., displays and one or more user input devices, such as a keyboard, a mouse, a touch screen, etc.) for presenting information and/or receiving user inputs.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The terminology used in the description of the embodiments herein is for the purpose of describing particular embodiments only and is not intended to be limiting of the invention. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, steps, operations, elements, components, and/or groups thereof.

What is claimed is:

1. An apparatus for positioning an object, the apparatus comprising:
a nonlinear rail;
a first carriage slidably coupled to the nonlinear rail for nonlinear movements along the nonlinear rail;
a second carriage distinct and separate from the first carriage and slidably coupled to the nonlinear rail for nonlinear movements along the nonlinear rail;
a mount for supporting the object; and
a frame coupled to the mount and including: (i) a first support member rotatably coupled to the first carriage; (ii) a second support member distinct and separate from the first support member and rotatably coupled to the second carriage; and (iii) a third support member distinct and separate from the first support member and the second support member for converting movements of the first support member, the second support member, and the third support member caused by the nonlinear movements of the first carriage or the second carriage to at least one of translation or rotation of the mount.

2. The apparatus of claim 1, wherein the nonlinear rail defines a closed path for the first carriage and the second carriage.

3. The apparatus of claim 1, wherein:
the nonlinear rail comprises:
a first end of the nonlinear rail; and
a second end of the nonlinear rail, opposite to the first end of the nonlinear rail; and
the first end and the second end of the nonlinear rail are not in contact with each other and the nonlinear rail extends nonlinearly from the first end to the second end.

4. The apparatus of claim 1, wherein:
the frame includes a first block rotatably coupled to the first support member and the second support member for rotation about respective rotational axes parallel to each other, wherein the first block is pivotally coupled to the third support member for rotation about a first pivotal axis perpendicular to the respective rotational axes.

5. The apparatus of claim 4, wherein:
the first block includes a first plate that defines a first slot, a second slot in line with the first slot, and a third slot perpendicular to the first slot and the second slot and positioned at an equal distance to the first slot and the second slot;
the first support member includes a first pin slidably coupled to the first slot;
the second support member includes a second pin slidably coupled to the second slot; and
the first support member and the second support member are rotatably coupled to a common pin that is slidably coupled to the third slot.

6. The apparatus of claim 5, wherein:
the first block includes a second plate distinct and separate from the first plate, the second plate defining a fourth slot parallel to the third slot;
at least a portion of the first support member and the second support member is located between the first plate and the second plate; and
the common pin is slidably coupled to the fourth slot.

7. The apparatus of claim 6, wherein:
the second plate defines a fifth slot parallel to the first slot and a sixth slot in line with the fourth slot;
the first support member includes a third pin slidably coupled to the fifth slot; and
the second support member includes a fourth pin slidably coupled to the sixth slot.

8. The apparatus of claim 6, wherein:
the frame includes one or more linkages, a respective linkage of the one or more linkages being pivotably coupled to the first block so that the respective linkage is pivotable about a second pivotal axis parallel to the first pivotal axis.

9. The apparatus of claim 8, wherein:
the respective linkage includes (a) a first link pivotably coupled to the first block about the second pivotal axis and (b) a second link pivotably coupled to the first link about a third pivotal axis parallel to the first pivotal axis, pivotably coupled to the third support member about a fourth pivotal axis parallel to the first pivotal axis, and pivotably coupled to the mount about a fifth pivotal axis parallel to the first pivotal axis.

10. The apparatus of claim 9, wherein:
the third support member is pivotably coupled to the mount about a sixth pivotal axis parallel to the first pivotal axis.

11. The apparatus of claim 1, wherein:
the frame includes a first block, a second block rotatably coupled to a first end of the first block, and a third block rotatably coupled to a second end, opposite to the first end, of the first block;
the first support member includes a first arm and a second arm distinct from the first arm;
the second support member includes a third arm and a fourth arm distinct from the third arm;
the first arm and the third arm are rotatably coupled to the first block;
the second arm is rotatably coupled to the second block; and
the fourth arm is rotatably coupled to the third block.

12. The apparatus of claim 1, wherein:
the frame includes a first block (i) rotatably coupled to the first support member for rotation about a first rotational axis, (ii) rotatably coupled to the second support member for rotation about a second rotational axis that is non-parallel to the first rotational axis, and (iii) pivotally coupled to the third support member for rotation about a first pivotal axis that is non-parallel to the first rotational axis and the second rotational axis.

13. The apparatus of claim 12, wherein:
the frame includes one or more linkages, a respective linkage of the one or more linkages being pivotably coupled to the first block so that the respective linkage is pivotable about a second pivotal axis parallel to the first pivotal axis.

14. The apparatus of claim 1, further comprising:
a third carriage that is (1) distinct and separate from the first carriage and the second carriage, (2) slidably coupled to the nonlinear rail for nonlinear movements along the nonlinear rail, and (3) rotationally coupled to the third support member;
a fourth carriage that is (1) distinct and separate from the first carriage, the second carriage, and the third carriage and (2) slidably coupled to the nonlinear rail for nonlinear movements along the nonlinear rail; and
a fifth carriage that is (1) distinct and separate from the first carriage, the second carriage, the third carriage, and the fourth carriage and (2) slidably coupled to the nonlinear rail for nonlinear movements along the nonlinear rail,
wherein the frame also includes:
(iv) a fourth support member that is (1) distinct and separate from the first support member, the second support member, and the third support member, (2) rotatably coupled to the fourth carriage, and (3) rotatably coupled to the mount; and
(v) a fifth support member that is (1) distinct and separate from the first support member, the second support member, the third support member, and the fourth support member, (2) rotatably coupled to the fifth carriage, and (3) rotatably coupled to the mount.

15. The apparatus of claim 14, wherein:
the frame also includes: (vi) a sixth support member (1) distinct and separate from the first support member, the second support member, the third support member, the fourth support member, and the fifth support member, and (2) rotatably coupled to the mount;
the first support member is rotatably coupled to the mount at a first location of the mount;
the second support member is rotatably coupled to the mount at a second location of the mount adjacent to the first location of the mount;
the third support member is rotatably coupled to the mount at a third location of the mount adjacent to the second location of the mount;
the fourth support member is rotatably coupled to the mount at a fourth location of the mount;
the fifth support member is rotatably coupled to the mount at a fifth location of the mount;
the sixth support member is rotatably coupled to the mount at a sixth location of the mount; and
the first location is separated from the second location by a first distance and the third location is separated from the second location by a second distance distinct from the first distance.

16. The apparatus of claim 1, wherein:
a respective support member of the first support member and the second support member is rotatably coupled to a caster with a caster body and one or more wheels rotatable about a wheel axis relative to the caster body;
the caster body is rotatable with the respective support member about a caster body axis perpendicular to the wheel axis; and
the one or more wheels of the respective support member are in contact with the nonlinear rail.

17. The apparatus of claim 16, wherein the one or more wheels of the respective support member have a substantially spherical shape.

18. The apparatus of claim 1, wherein the nonlinear rail includes a first portion with a rail track and a second portion with a plurality of gear teeth.

19. The apparatus of claim 18, wherein a respective carriage of the first carriage and the second carriage includes one or more drive actuators mated to the plurality of gear teeth such that activation of the one or more drive actuators causes a nonlinear movement of the respective carriage along the nonlinear rail.

20. A method of adjusting a position of an object mounted on the apparatus of claim 1, the method comprising:
moving the first carriage and the second carriage symmetrically to each other to concurrently adjust a height and a pitch of the object without adjusting a lateral position or a yaw of the object; and
moving at least one of the first carriage or the second carriage non-symmetrically to each other to concurrently adjust at least a lateral position and a yaw of the object.
